(19) United States
(12) Patent Application Publication
(10) Pub. No.: US 2026/0124830 A1
(43) Pub. Date: May 7, 2026

(54) AUTO FEED DTF FILM HEAT PRESS MACHINE

(71) Applicants: Dawei CAO, Shenzhen (CN); Enetshops, LLC, Fullerton, CA (US)

(72) Inventors: Jimmy LIN, Yorba Linda, CA (US); Dawei CAO, Shenzhen (CN)

(21) Appl. No.: 19/379,421

(22) Filed: Nov. 4, 2025

(30) Foreign Application Priority Data
Nov. 6, 2024 (CN) 202422700205.2

(51) Int. Cl. B32B 41/00; B32B 37/00

(52) U.S. Cl. CPC B32B 41/00; B32B 37/025; B32B 2041/04; B32B 2437/00

(57) ABSTRACT

The present disclosure relates to automatic heat-transfer press machines and systems configured to transfer printed patterns from a carrier film onto garments. Various embodiments are described, including single-station, dual-platen, multi-station, and continuous conveyor configurations. The machines may include automated film feeding, edge and print-edge alignment systems, vacuum garment retention, programmable temperature and pressure control, and selectable hot, warm, or cold peel cycles. Certain embodiments may incorporate vision-based or AI-powered alignment systems that automatically correct garment or film misalignment in real time. Other embodiments include forced-air cooling to accelerate peel readiness and integrated sensors for monitoring actual garment temperature and pressure uniformity. The disclosure describes both the structural configurations and detailed methods of setup and operation that allow for consistent, high-quality transfers with reduced operator error and improved production efficiency across a variety of garment types and transfer films.

### CROSS REFERENCE TO RELATED APPLICATIONS

This application claims priority to patent application serial number 202422700205.2, filed on Nov. 6, 2024 with the CNIPA, the entire contents of which are expressly incorporated herein by reference.

### STATEMENT RE: FEDERALLY SPONSORED RESEARCH/DEVELOPMENT

Not Applicable.

### BACKGROUND

The various aspects and embodiments described herein relate to a heat press machine (DTF Film and heat transfer press).

In the prior art, garment printing systems typically performed heat transfer operations one at a time. Each transfer required manual positioning and sequential pressing of individual garments, resulting in slow production speeds and limited throughput. Accordingly, there is a need in the art for a heat transfer system that can improve throughput by automating or continuously performing transfer operations.

### BRIEF SUMMARY

The disclosed invention provides a family of automated heat-transfer press machines designed to increase production efficiency and improve the accuracy and consistency of direct-to-film (DTF) garment transfers. The machines achieve these benefits by combining precise film-handling mechanisms, adjustable lower platen movement, and integrated sensors and cameras that continuously monitor and adjust alignment during operation. By automating critical steps such as film positioning, garment centering, peel timing, and cooling, the system reduces manual intervention and ensures that every transfer is applied under optimal temperature and pressure conditions.

Unlike traditional heat presses that rely on operator skill for placement and timing, the embodiments described herein use feedback-driven control and optional AI vision correction to ensure uniform results from cycle to cycle. The modular design allows features such as vacuum garment retention, roll-to-roll film peeling, and programmable peel delays to be implemented selectively across single or multi-platen configurations, offering scalable automation for both small and industrial production environments.

More particularly, an automatic heat-transfer press machine is disclosed. The machine may comprises a lower platen configured to support a garment. It includes an upper platen defining a heated surface that presses a sheet carrying a printed pattern against the garment. The upper platen moves vertically in a linear path between an up position and a down position. The machine also includes a roll-feeding mechanism that feeds the sheet along a sheet path from a supply roll, through a press zone, and to a take-up roll. A controller operates the upper platen and roll-feeding mechanism independently. During a press cycle, the upper platen lifts away from the sheet after a dwell period while the sheet remains at the garment's elevation to allow controlled cooling of the printed pattern. After a time delay, the roll-feeding mechanism lifts or peels the sheet away from the garment.

The delay is programmable between about one second and one minute to provide hot-peel, warm-peel, or cold-peel modes. The controller includes a user interface that allows an operator to set the time delay between lifting of the upper platen and lifting of the roll-feeding mechanism. The controller may automatically select the delay based on a detected type of sheet or a stored recipe for a particular transfer material.

The machine may include an airflow system that directs ambient or cooled air across the garment during the delay to speed up cooling of the printed pattern. The airflow system can include one or more fan blowers or air nozzles directed between the upper platen and the garment, and the controller may regulate air temperature during the delay. The roll-feeding mechanism can tilt about a transverse axis before lifting the sheet to start peeling from one side of the printed pattern before peeling the rest, so the sheet peels off from one side to the opposite side. The machine can include a non-contact temperature sensor that measures the temperature of the garment surface, and the controller regulates the upper platen temperature based on when the measured temperature reaches a target value. The sheet may be a direct-to-film (DTF) film or a heat transfer paper.

In another aspect, an automatic press machine is disclosed. The machine may include a lower platen for receiving a garment and a roll-feeding mechanism for advancing a sheet carrying printed patterns between the upper and lower platens. A print-edge detector is positioned along the sheet path to detect a leading edge of each printed pattern. A controller advances the sheet after detection of the leading edge for a calibrated distance or duration so that the printed pattern is properly aligned with the garment on the lower platen.

The controller stores adjustable calibration parameters that match different printed pattern spacing and sizes for repeatable alignment. The print-edge detector can be an optical or infrared sensor that detects contrast between printed and unprinted regions of the sheet. The calibrated advancement distance is adjustable through a user interface and can be stored as a job preset. The print-edge detector controls vertical placement of the printed pattern and works with a front-to-back edge sensor to regulate left-to-right placement on the garment.

An artificial intelligence (AI) camera may be placed above the lower platen to verify printed pattern placement after the sheet advances and before pressing. The controller can adjust the sheet or lower platen position based on alignment feedback from the AI camera to correct misalignment. The print-edge detector may detect each printed pattern automatically during continuous operation so that every garment receives identical positioning without manual adjustment.

In another aspect, an automatic heat-transfer press machine is disclosed. The machine may include a roll-feeding mechanism that advances a sheet carrying printed patterns toward a press zone. A guide is located along the sheet path and can rotate about an axis to shift the sheet front-to-back, adjusting the printed pattern's vertical position on the garment. An edge sensor monitors a side edge of the sheet and sends positional feedback to the controller. The controller moves the guide in response to that feedback to adjust each printed pattern's vertical placement on the garment. The guide maintains consistent pattern height despite lateral drift over repeated cycles.

The guide's movement may be rotational in a clockwise or counterclockwise direction or may move laterally in and out. The guide can include a pair of rollers mounted on a pivot frame rotated by an actuator under controller command. Rotation of the guide changes sheet height to adjust landing position. The edge sensor may be on an adjustable bracket with a thumb wheel for fine adjustment. The controller continuously monitors the edge sensor and makes small guide movements to keep the sheet within tolerance. The guide and edge sensor together maintain automatic alignment through repeated cycles regardless of roll diameter, winding uniformity, or sheet tension.

In another aspect, an automatic heat-transfer press machine is disclosed. The machine may include a lower platen mounted on a movable base. The base translates between an in position beneath an upper platen and an out position where an operator loads garments. Movement between the in and out positions is actuated by a pneumatic cylinder, an electromechanical actuator, or manually by the operator. The movement is limited by an adjustable stopper defining the terminal in position for repeatable alignment of the garment under the upper platen, providing a drawer-style system that can be semi-automatic or fully automatic, or by a linear actuator.

The in position of the lower base may be determined by a feedback signal from an edge sensor. Linear guide rails can support the lower platen and keep it parallel while moving. The lower platen can include a throat portion that allows one layer of the garment to lie on the platen while another layer hangs below. The lower platen can have vacuum ports to hold the garment during movement. The vacuum ports may be around the periphery of the platen to avoid interference with the printed pattern. The machine can also include a mechanical frame or magnetic clamps around the platen to hold the garment while the lower base moves. The lower platen movement may be controlled by a foot pedal or a start switch connected to the controller.

In another aspect, an automatic heat-transfer press machine is disclosed. The machine may include an upper platen movable between raised and lowered positions to press a garment and sheet together. A lower platen supports the garment. A safety sensor is positioned along the front of the machine and detects when a hand or foreign object is present. The controller stops downward motion of the upper platen if an obstruction is detected within a defined safety zone. The safety sensor may include optical beams, infrared emitters, or light curtains across the front to ensure operator safety.

A visual or audible alarm may activate when the safety sensor detects the obstruction.

In another aspect, a method of setting up an automatic heat-transfer press machine is disclosed. The method may include installing a roll of sheet carrying printed patterns onto a supply spindle of a roll-feeding mechanism. The sheet is threaded through rollers and its leading edge attached to a take-up spindle. An edge sensor is positioned relative to a sheet edge to set a lateral reference. The sensor is fine-tuned using an adjustment mechanism until the printed pattern aligns vertically with the lower platen. A print-edge detector is calibrated to detect a leading edge of the printed pattern, and a sheet-advance distance is stored in a controller to ensure each pattern is properly positioned over the garment. A garment is placed on the lower platen.

The garment may be positioned so that one layer lies on the platen surface and another below it. A garment-retention system may be activated to hold the garment in place. The retention system can include vacuum ports, a mechanical frame, or magnetic clamps around the platen. A guide upstream of the press zone may be rotated to correct vertical placement. Laser alignment beams may be activated and the garment adjusted until a mark aligns with the beams. Process parameters such as platen temperature, dwell time, pressure, peel delay, and sheet advance distance are entered into a user interface. The controller stores the setup as a recipe for a particular sheet type or garment material. A stopper defining the in position of the lower platen may be adjusted for proper placement. An AI camera may analyze the garment and printed pattern and direct the controller to correct alignment before pressing.

In another aspect, a method of operating an automatic heat-transfer press machine is disclosed. The method may include moving the lower platen carrying a garment to an in position beneath an upper platen. The sheet carrying a printed pattern is advanced into alignment with the garment. The upper platen lowers to press the sheet and garment together under preset temperature, pressure, and dwell time. The upper platen lifts after the dwell period to allow cooling of the printed pattern while keeping contact between the sheet and garment. After a delay, the sheet is lifted or peeled from the garment to complete the transfer. The lower platen then returns to an out position for garment removal and reloading.

The delay is programmable between one second and one minute to define hot-peel, warm-peel, or cold-peel cycles. The roll-feeding mechanism or upper platen may tilt so one edge of the sheet lifts first. Airflow may be directed across the printed pattern after lifting the upper platen and before peeling to speed cooling. The controller may trigger peeling when a surface temperature measured by a sensor under the upper platen reaches a programmed target. A print-edge detector may detect the leading edge of the printed pattern and advance the sheet by a calibrated distance before pressing.

The machine may continuously monitor a side edge of the sheet with an edge sensor and rotate a guide to regulate the printed pattern's vertical position. An AI camera may monitor pattern alignment and automatically adjust sheet or platen position. The garment may be held to the lower platen by vacuum, mechanical, or magnetic retention. A safety sensor may detect an obstruction in front of the upper platen and prevent it from moving down. The safety sensor may include a light curtain, optical beam, or infrared detector. Temperature, pressure, and timing data for each press cycle may be recorded for traceability. The controller coordinates the timing of the upper platen, roll-feeding mechanism, and airflow to keep transfer quality consistent. The machine can perform successive press cycles automatically by advancing the sheet and repositioning the lower platen after each cycle.

In another aspect, a method of operating an automatic heat-transfer machine is disclosed. The method may include feeding a continuous heat transfer sheet that carries multiple printed patterns. Each pattern is separated by a first spacing region before the pattern and a second spacing region after it. The first spacing region is uncoated, and the second is coated with a finishing layer. The sheet is advanced so that the first spacing region is between the upper and lower platens. The upper platen lowers to apply a pre-press operation to a garment on the lower platen, preparing the surface for transfer. The sheet is advanced so the printed pattern is between the platens. The upper platen lowers to transfer the printed pattern to the garment. The sheet is advanced again so that the second spacing region is between the platens. The upper platen lowers again to perform a post-press operation applying the finishing layer. The sheet is then advanced to the first spacing region of the next printed pattern and the cycle repeats.

The pre-press operation flattens garment fibers and removes moisture. The post-press operation fuses the finishing layer to add gloss, matte, or protective finish. The heat transfer sheet may be a DTF film or heat transfer paper with alternating uncoated and coated spacing regions. The pre-press and post-press operations can be at different temperature and pressure settings controlled by a programmable logic controller. The coating may include resin, wax, or polymer to give a visual or tactile finish. Sheet advancement can be automatically indexed using a sensor detecting the spacing regions. The uncoated and coated regions may be pre-defined during sheet manufacture. Each of the pre-press, transfer, and post-press steps can be independently controlled for time, temperature, and pressure. The entire cycle repeats automatically to transfer patterns continuously to multiple garments.

In another aspect, a method of performing a heat-transfer process is disclosed. The method may use a heat-transfer press and a roll of film carrying multiple patterns spaced by a pre-press region between adjacent patterns. The film is advanced so that a pre-press region lies between the upper and lower platens. A garment is placed on the lower platen. The upper platen lowers to press the garment through the pre-press region to remove wrinkles and moisture before transfer. The upper platen then lifts. The film is advanced so that a printed pattern is between the upper platen and garment. The upper platen lowers again to press the pattern and film against the garment under heat and pressure for a set dwell time, transferring the pattern. The platen lifts, and the film is peeled from the garment.

The pre-press region of the film is uncoated, so heat and pressure are applied directly to the garment surface without affecting transfer quality. The heat and pressure during pre-pressing are lower than during transfer.

In another aspect, a method of performing a heat-transfer process is disclosed. The method may use a press and a roll of film carrying patterns spaced by a post-press region located after each pattern along the film feed direction. The film is advanced so that a first pattern is between the upper and lower platens. A garment is placed on the lower platen. The upper platen lowers to press the pattern and film against the garment under heat and pressure for a set dwell time, transferring the pattern. The upper platen lifts. The film is advanced so that the post-press region is between the platens after transfer. The upper platen lowers again to apply a post-press operation through the post-press region to finish the pattern.

The post-press region of the film may be coated with a finish layer to create matte, glossy, or textured surfaces. The post-press region may instead be uncoated and used to thermally smooth the garment surface and improve adhesion. The temperature and pressure during post-pressing are less than during transfer. The upper platen may be kept between 120° C. and 180° C. during transfer and between 100° C. and 160° C. during post-pressing.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a single-station DTF heat-transfer press machine, showing the overall arrangement of the roll-feeding mechanism, press zone, and upper and lower platens.

FIG. 2 is a right-side view of the machine of FIG. 1, illustrating the take-up spindle and general film path after the press zone.

FIG. 3 is a left-side view of the machine of FIG. 1 showing the supply spindle, motors, guide, edge sensor, film feeding components and the general film path before the press zone.

FIG. 4 is an enlarged view of the edge sensor mounted to an adjustable bracket and thumb wheel used to align the film transversely.

FIG. 5 is a schematic view of a print-edge detector sensing the leading edge of a printed pattern on the film for controlling left to right positioning on the lower platen.

FIG. 6 shows a square-shaped lower platen suitable for general shirt transfers.

FIG. 7 shows a circular lower platen for smaller or circular garments or fabric articles.

FIG. 8 shows a laser alignment module projecting alignment beams onto the lower platen to assist garment positioning.

FIG. 9 shows the garment positioned on the lower platen and aligned using projected laser beams.

FIG. 9A illustrates a human machine interface.

FIG. 10 shows the frame descending to level the film relative to the lower platen before pressing begins.

FIG. 11 shows the upper platen pressing the film and garment together during the heat-transfer cycle.

FIG. 12 shows the upper platen lifted slightly for controlled cooling while the film remains lowered.

FIG. 13 shows the frame and film raised to peel the film from the garment and heat transfer pattern following the programmed delay interval.

FIG. 14 shows a dual-platen embodiment having two upper platens arranged for alternating operation under a single lower platen wherein the lower platen is movable in and out of the machine.

FIG. 15 shows the dual-platen embodiment shown in FIG. 14 with the lower platen under the first upper platen.

FIG. 16 shows the dual-platen embodiment shown in FIG. 14 with the first upper platen traversed downward.

FIG. 17 shows the dual-platen embodiment shown in FIG. 14 with the first upper platen traversed upward.

FIG. 18 shows the dual-platen embodiment shown in FIG. 14 with the lower platen traversed under the second upper platen.

FIG. 19 shows the dual-platen embodiment shown in FIG. 14 with the second upper platen traversed downward.

FIG. 20 shows the dual-platen embodiment shown in FIG. 14 with the second upper platen traversed upward.

FIG. 21 shows the dual-platen embodiment shown in FIG. 14 with the lower platen traversed under the first upper platen first then the first upper platen traversed downward.

FIG. 22 shows the dual-platen embodiment shown in FIG. 14 with the lower platen traversed to the loading position so that the operator can remove the garment that was worked on and place a new garment on the lower platen for the next pressing cycle.

FIG. 23 shows a multi-platen embodiment with two upper platens for pre press, press and post press operations wherein the lower platen is movable side to side between the upper platens.

FIG. 24 shows the multi platen embodiment shown in FIG. 23 with the first upper platen traversed downward.

FIG. 25 shows the multi platen embodiment shown in FIG. 23 with the first upper platen traversed upward, then the lower platen traversed sideways, then the second upper platen traversed downward.

FIG. 26 shows the multi platen embodiment shown in FIG. 23 with the second upper platen traversed upward, then the lower platen traversed sideways under the first upper platen, then the first upper platen traversed downward.

FIG. 27 shows the multi platen embodiment shown in FIG. 23 with the lower platen traversed to the loading position so that the operator can remove the garment that was worked on and place a new garment on the lower platen for the next pressing cycle.

FIG. 28 shows a triple station heat press for simultaneous dual pressing.

FIG. 29 shows a front schematic view of the triple station heat press of FIG. 28 with the first and third upper platens in the up position and the middle upper platen (press station) in the lowered position, and the first lower platen in the loading position while the second lower platen is under the middle upper platen.

FIG. 30 shows the front schematic view of the triple station heat press of FIG. 28 with the middle upper platen traversed to the up position, then the first and second lower platens traversed under the first and third upper platens, then the first and third upper platens traversed to the down position.

FIG. 31 shows the front schematic view of the triple station heat press of FIG. 28 with the first and third upper platens traversed to the up position, then the first lower platen traversed under the middle platen and the second lower platen traversed to the loading position, then the middle platen traversed to the down position.

FIG. 32 shows the front schematic view of the triple station heat press of FIG. 28 with the middle upper platen traversed to the up position, then the first and second lower platens traversed to be under the first and third upper platens, and then the first and third upper platens traversed to the down positions.

FIG. 33 shows the front schematic view of the triple station heat press of FIG. 28 with the first and third upper platens traversed to the up position, then the first lower platen traversed to the out position and the second lower platen traversed to under the middle platen, and then the middle platen traversed to the down position.

FIG. 34 shows a further embodiment of the heat press with a single elongate upper platen wherein the lower platen moves up and down and between loading and pressing positions.

FIG. 35 shows the heat press embodiment of FIG. 34 with the lower platen traversed below a first portion of the upper platen.

FIG. 36 shows the heat press embodiment of FIG. 34 with the lower platen traversed upward.

FIG. 37 shows the heat press embodiment of FIG. 34 with the lower platen traversed downward.

FIG. 38 shows the heat press embodiment of FIG. 34 with the lower platen traversed under a second portion of the upper platen and the film.

FIG. 39 shows the heat press embodiment of FIG. 34 with the lower platen traversed in the up position.

FIG. 40 shows the heat press embodiment of FIG. 34 with the lower platen traversed to the lowered position and the heat transfer pattern disposed on the garment.

FIG. 41 shows the heat press embodiment of FIG. 34 with the lower platen traversed to under the first portion of the upper platen and then to the up position.

FIG. 42 shows the heat press embodiment of FIG. 34 with the lower platen traversed to the lowered position and then to the loading position.

FIG. 43 shows a further embodiment of the heat press with a single elongate upper platen wherein the upper platen moves up and down and the lower platen moves between pressing and loading positions.

FIG. 44 shows the heat press embodiment shown in FIG. 43 with the upper platen traversed to the down position.

FIG. 45 shows the heat press embodiment shown in FIG. 43 with the upper platen traversed to the up position.

FIG. 46 shows the heat press embodiment shown in FIG. 43 with the lower platen traversed to under a second portion of the upper platen and under a film and heat transfer pattern.

FIG. 47 shows the heat press embodiment shown in FIG. 43 with the upper platen traversed to the down position.

FIG. 48 shows the heat press embodiment shown in FIG. 43 with the upper platen traversed to the up position.

FIG. 49 shows the heat press embodiment shown in FIG. 43 with the lower platen traversed to under the first portion of the upper platen.

FIG. 50 shows the heat press embodiment shown in FIG. 43 with the upper platen traversed to the down or lowered position.

FIG. 51 shows the heat press embodiment shown in FIG. 43 with the upper platen traversed to the up position.

FIG. 52 shows the heat press embodiment shown in FIG. 43 with the lower platen traversed to the loading position.

FIG. 53 shows a three-heat-press embodiment wherein each of the heat presses operates independently of the others but is used as a dedicated pre-press heat press station, a heat transfer heat press station, and a post-press heat press station.

### DETAILED DESCRIPTION

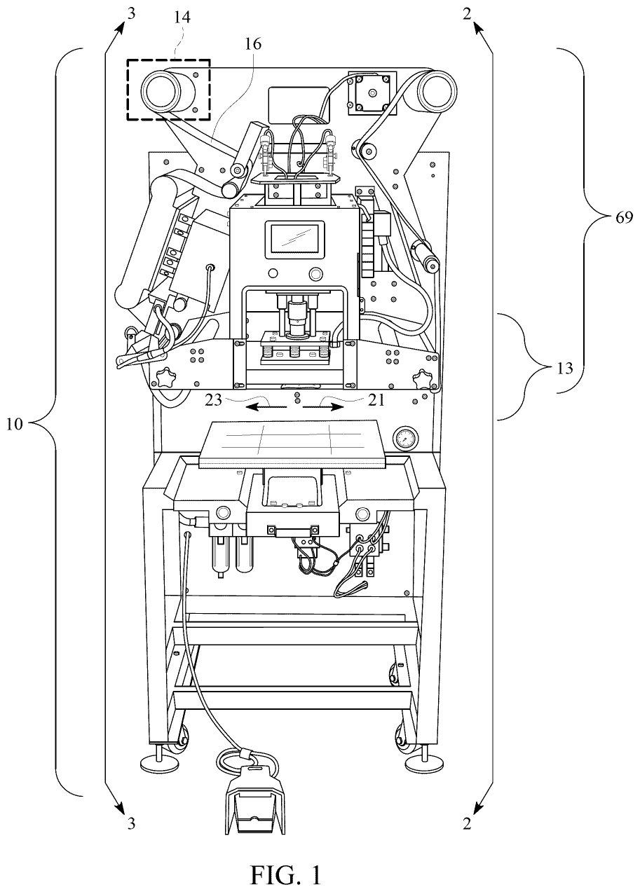

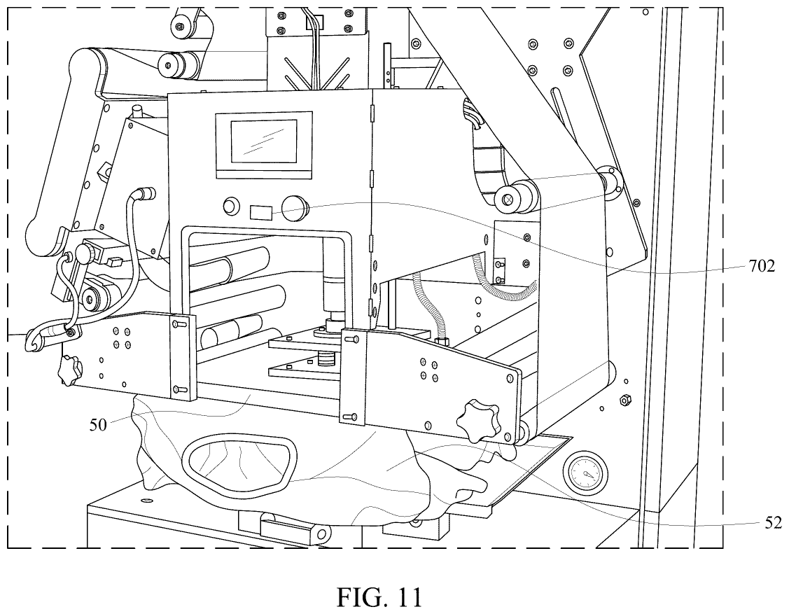

The present disclosure relates to semi-automatic and fully automatic direct-to-film (DTF) heat-transfer press machines configured to transfer printed patterns from a carrier film onto garments with improved consistency, safety, and automation. In general, the machines include a lower platen (40) that supports a garment (52), an upper platen (50) that applies controlled heat and pressure, and a roll-feeding mechanism (69) that advances a film (16) carrying printed patterns (18) between a supply spindle (20a) and a take-up spindle (20b). The overall arrangement is shown in FIGS. 1-3. During operation, the upper platen (50) and the roll-feeding mechanism (69) are operated independently by a controller so that, after a dwell period, the upper platen lifts first to permit controlled cooling of the transferred pattern on the garment, while the roll-feeding mechanism lifts the film thereafter following a programmed delay. As shown in FIGS. 11-13, this sequence produces selectable hot, warm, or cold peel cycles, depending on the chosen delay interval, enabling compatibility with all major DTF film types.

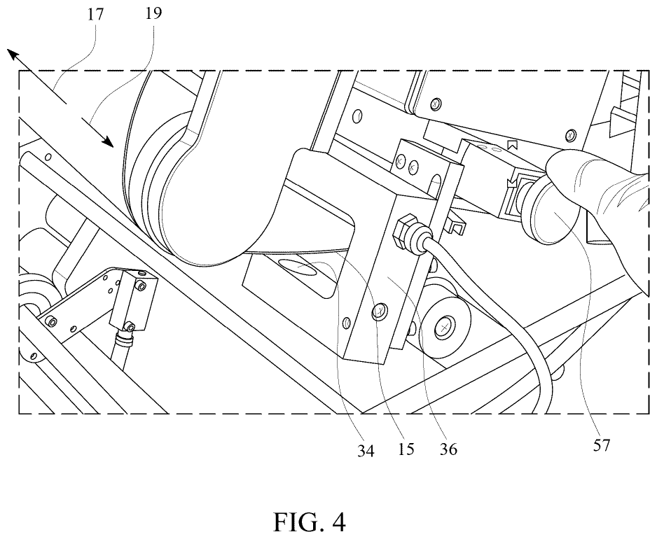

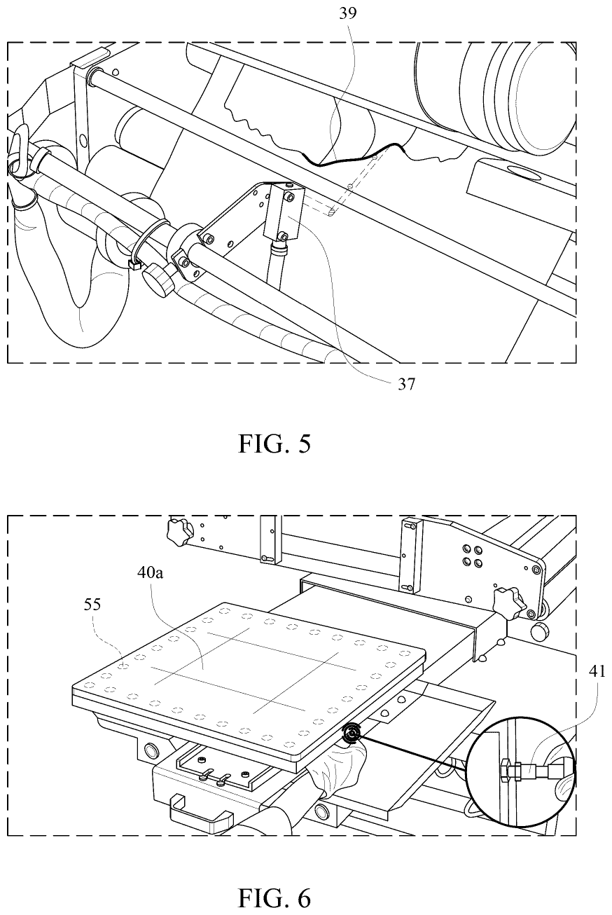

The invention further provides a precision film alignment and garment positioning system. A print-edge detector (37) located along the film path detects the leading edge (39) of each printed pattern (18) and signals the controller to advance the film a calibrated distance so that each image is centered over the garment (52). An edge sensor (34) and a steerable guide (33) continuously monitor and adjust the lateral position of the film, maintaining repeatable alignment from cycle to cycle. In certain embodiments, an AI camera positioned above the press zone (13) monitors both the printed pattern and the garment edges and automatically commands minor corrections to the film or the lower platen (40) to ensure accurate registration. As illustrated in FIGS. 4-5, this combination of edge and print-edge sensing systems ensures both vertical and horizontal pattern alignment prior to each pressing cycle.

The lower platen (40) may be configured as a slide-out drawer mounted on linear rails or a movable base (38), as shown in FIGS. 6-9. The platen can be manually moved or actuated by a pneumatic or electromechanical drive to traverse between an out position for garment loading and an in position beneath the upper platen (50). A stopper may define the exact in position, ensuring consistent depth alignment under the upper platen. The lower platen may include a throat opening allowing only one fabric layer of the garment (52) to rest on its top surface, while the opposite layer hangs beneath. Garment retention may be achieved using vacuum ports (55), a mechanical clamping frame, or a plurality of magnetic clamps distributed around the platen's periphery to prevent garment movement during translation or pressing.

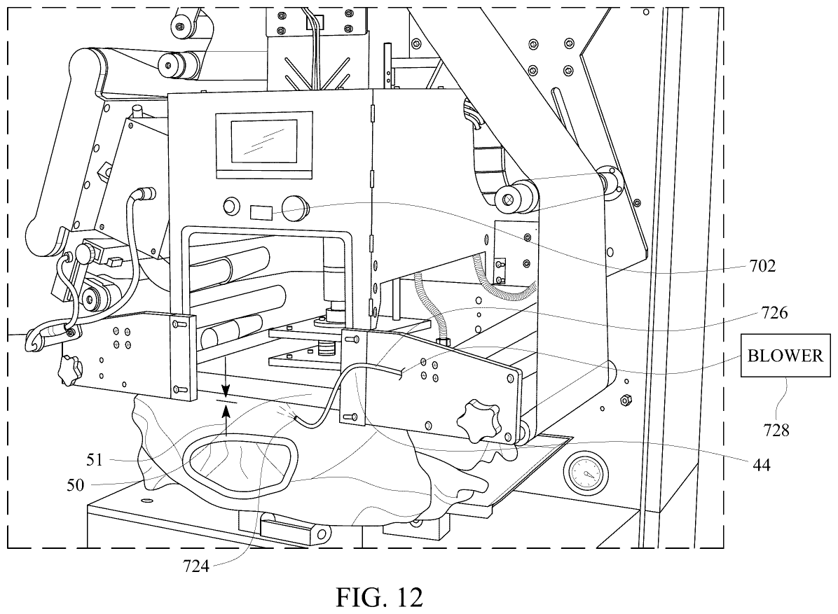

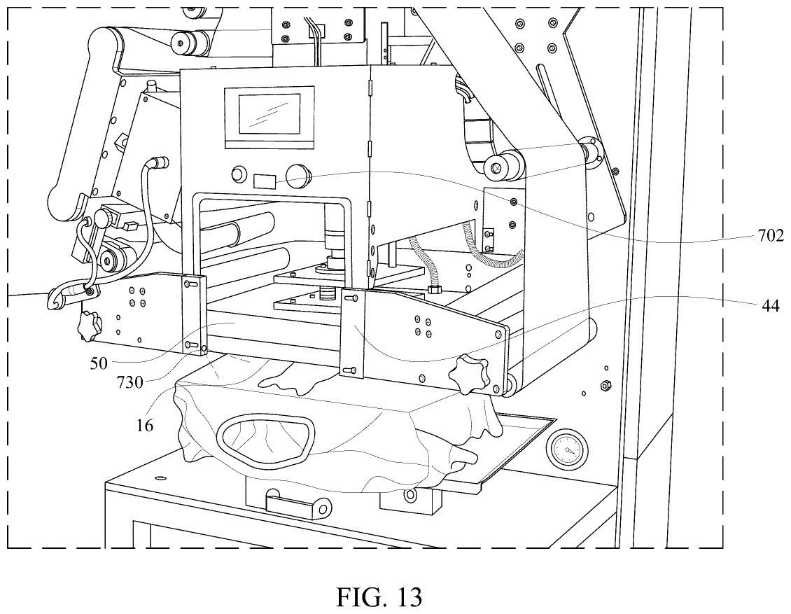

The machine also incorporates operator safety and process consistency features. One or more optical safety sensors or light curtains positioned along the front edge of the frame (44) prevent downward motion of the upper platen (50) if the operator's hands or any obstruction are detected in the press zone (13). Integrated temperature and pressure sensors monitor the actual surface temperature of the garment and the uniformity of applied pressure across the platen face, feeding real-time data to the controller for quality assurance. A forced-air cooling system (see FIGS. 12-13) may direct ambient or cooled air across the transfer area between the lifting of the upper platen (50) and the lifting of the film (16), reducing the cooling delay and increasing throughput during warm or cold peel cycles.

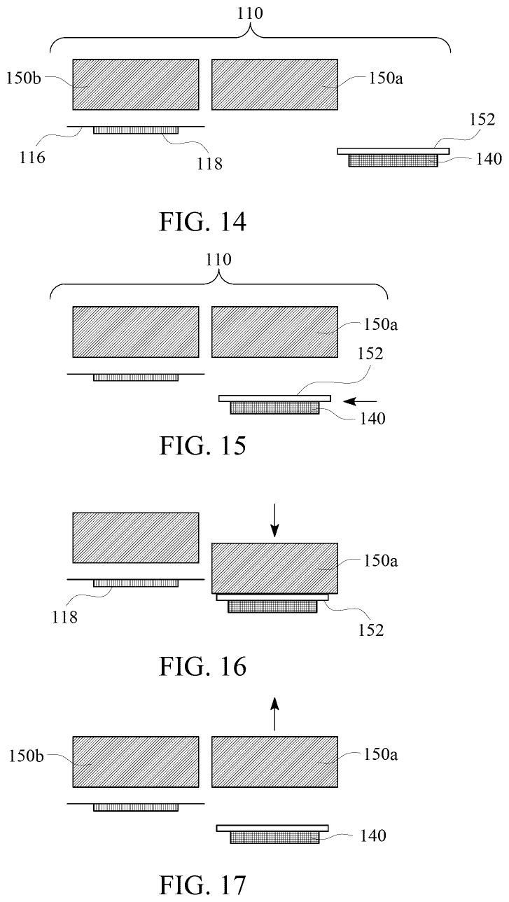

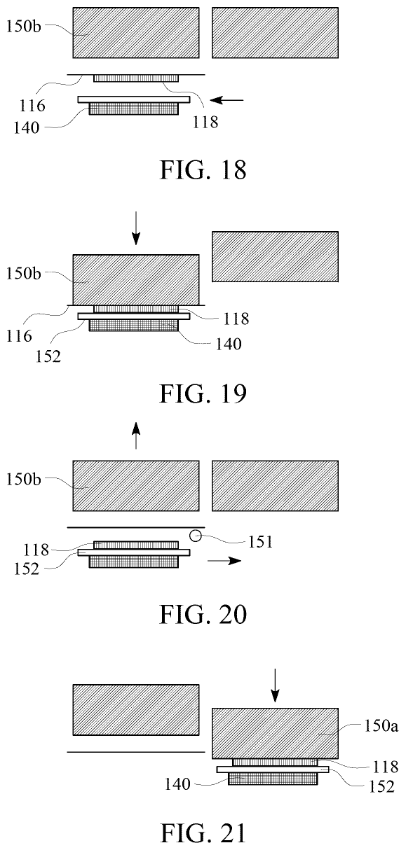

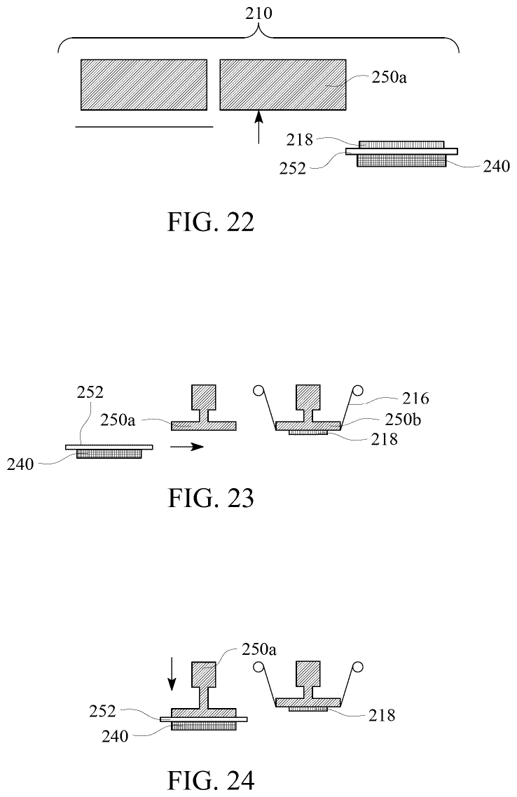

The disclosed embodiments also encompass multi-station and continuous systems (FIGS. 14-53) that use the same control logic and peeling sequence principles while employing multiple lower platens, rotating carousels, or continuous conveyor belts (640) to enable high-volume operation. Across all configurations, the invention provides improved film-handling accuracy, automated peel control, and enhanced operator safety, thereby achieving consistent transfer quality, reduced waste, and greater production efficiency compared to conventional heat-press systems.

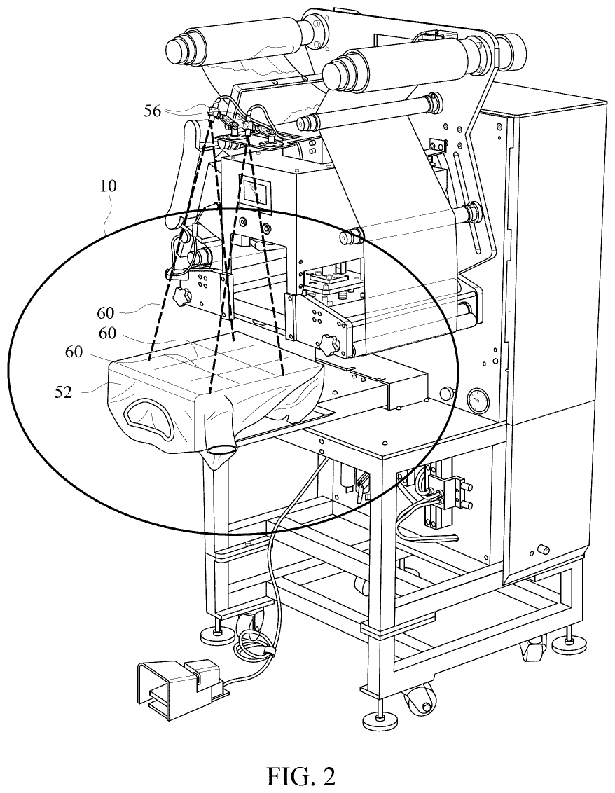

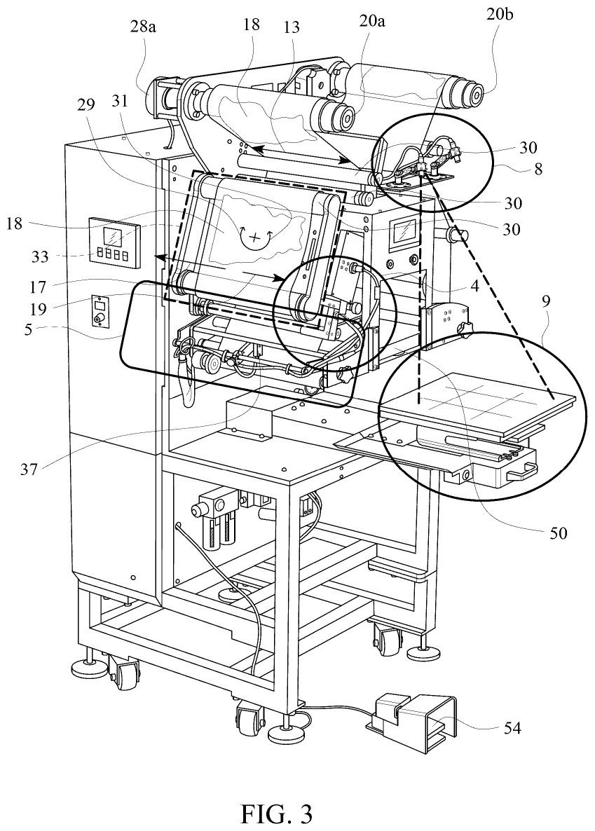

More particularly, referring now to FIGS. 1-13, the machine 10 is a single-station heat-transfer press designed for auto feeding direct to film (DTF) heat transfers. The operator stands in the front of the machine 10 during operation. In FIG. 1, machine 10 is shown head-on showing the general arrangement of the roll 14 of film 16 above the press zone 13, the roll feeding mechanism 69 and the position of the upper platen 50 relative to the lower platen 40. In FIG. 2, the right side of the machine 10 is shown to show the take-up spindle 20b. In FIG. 3, the left side of the machine 10 is shown to show the supply spindle 20a, motors 28a and 28b, guide 33, edge sensor 34, and the general web path of film 16 from the spindle 20a through the press zone 13 to spindle 20b.

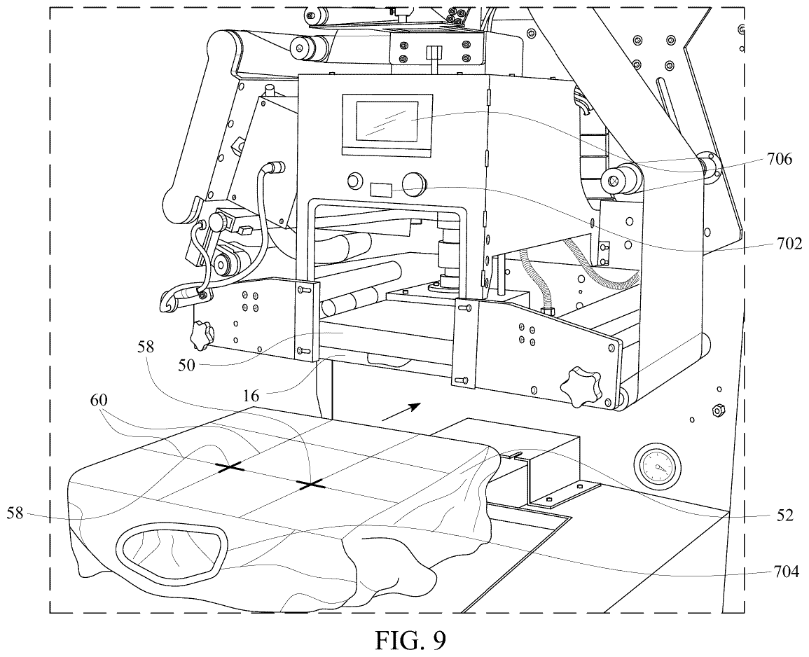

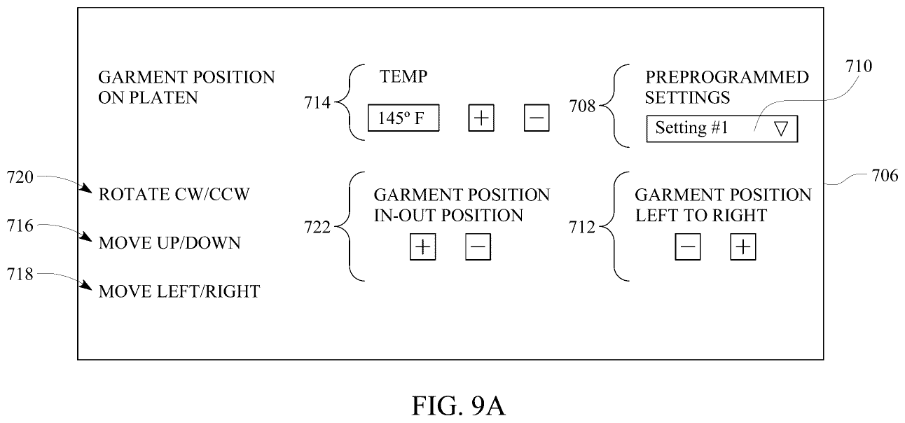

Roll 14 is a long length of film 16 which is initially rolled up. The film 16 has multiple transfer patterns 18 spaced apart from each other. In FIGS. 1 and 3, roll 14 is positioned so film 16 feeds smoothly into the roll feeding mechanism 69 without sharp bends. Film 16 carries the individual printed patterns 18, which will be transferred onto a shirt 52. One longitudinal edge 15 (see FIG. 4) of film 16 is used to steer and align the pattern 18 to the lower platen and the shirt. Patterns 18 on film 16 are spaced so that one pattern 18 at a time can be staged under the upper platen 50 during each press cycle (see FIGS. 9-11 for that cycle). After each press cycle, the film is advanced until the next pattern is disposed in the press zone 11.

Roll feeding mechanism 69 (see FIG. 1) is the web-handling subassembly that moves the film 16 from spindle 20a through the press zone 13 and then to the spindle 20b. Roll feeding mechanism 69 has a supply spindle 20a, take-up spindle 20b, and a series of rollers 30 that manage to feed the film between the upper and lower platens (i.e., press zone 13) to the spindle 20b. Supply spindle 20a is driven by motor 28a to release the film into the roll feeding mechanism 69. Take-up spindle 20b is driven by motor 28b to gather film 16 after the transfer is completed. Motors 28a and 28b may be coordinated so motor 28b runs at a slightly higher surface speed than motor 28a. This slight difference in speed establishes a small, steady tensile bias in film 16 and limits wrinkling. The film is wrapped around rollers 30. At least one of the rollers can be a spring-biased roller 30 to apply tension to the film.

The film 16 defines an edge 15 (see FIG. 4) which is a longitudinal side of film 16. Edge sensor 34 observes edge 15 continuously so the system can detect drift of the film into or out of the machine 10. To sense the edge, the edge sensor 34 may be an ultrasonic sensor, optical sensor or IR sensor (i.e., infra red sensor).

In FIG. 4, edge sensor 34 is mounted on bracket 36, and bracket 36 is adjustable in and out of the machine by a thumb wheel 57. When the edge sensor 34 detects that the film is too far into the machine 10, a guide 33 discussed herein shifts the film out of the machine 10 until the edge sensor detects that the film is at the right location. When the edge sensor 34 detects that the film is too far out of the machine 10, the guide shifts the film into the machine 10 until the edge sensor detects that the film is at the right location. FIG. 4 also illustrates how the operator can turn the thumb wheel 37 to set the position of the film.

Guide 33 (see FIG. 3) is a steerable web guide that corrects transverse shifting of the film 16. In FIG. 3, film is routed through the guide 33 and is positioned upstream of the press zone 13. If film 16 tends to drift “into” machine 10 (arrow 17) or “out of” machine 10 (arrow 19), guide 33 is rotated slightly clockwise 29 to bring the film further out of the machine or counterclockwise 31 to bring the film further into the machine. This action nudges the path of the film back to its original location as set by the operator when he/she turned the knob 57. The machine keeps the same vertical landing height of pattern 18 on the lower platen and thus the garment 52 each time. This closed-loop action uses edge sensor 34 as feedback to command the rotation position of the guide 33. The machine may have a computer loaded with software that is connected to the sensor 34 and controls rotation 29/31 of the guide 33.

A print-edge detector at 37 is used for left-to-right placement of the pattern 18 on the garment 52. In FIG. 5, the print-edge detector at 37 senses the leading edge 39 of the next pattern 18 on film 16. Once leading edge 39 is detected, motors 28a and 28b advance film 16 a calibrated distance or time so pattern 18 is positioned at the correct left to right location over the garment 52 and the lower platen. This keeps the placement of the pattern 18 on the garment repeatable. The machine 10 may include a computer and software that allow the operator to set the calibrated distance in small increments aft or fore and to store job-specific presets in memory. The film is advanced after the upper platen is traversed upward after a press cycle has just been completed to position the pattern 18 with the lower platen. The print edge detector 37 may detect the leading edge before or before the advancement of the film.

Lower base 38 moves into and out of the machine 10. The lower base 38 also supports the lower platen 40. In FIGS. 2 and 3, lower base 38 and the lower platen are extended (“out” position) to present the work area to the operator for loading the garment 52. The lower base 38 and the lower platen are then retracted (“in” position) to place the lower platen 40 and the garment 52 under the upper platen. A stopper may be adjustably positioned behind the lower base. The lower base may bump into the stopper and then stop moving. To move the lower base further into the machine, and thus the lower platen further into the machine, the stopper may be moved further into the machine. Conversely, to move the lower base out of the machine, and thus the lower platen out of the machine, the stopper may be moved further out of the machine. The stopper or the lower base 38 may be manually, electromechanically, or pneumatically actuated. The stopper or lower base position and/or movement may be actuated with foot pedal 54 or a start button. The location of the stopper can be adjusted in small increments based on edge sensor 37 input so lower base 38 shifts slightly in depth to match the shift of the film path. This may be controlled through the HMI 706 via in-out position buttons 722. This in and out adjustment may be in addition to the guide 33 and sensor 34 or in lieu of the guide 33 and sensor 34.

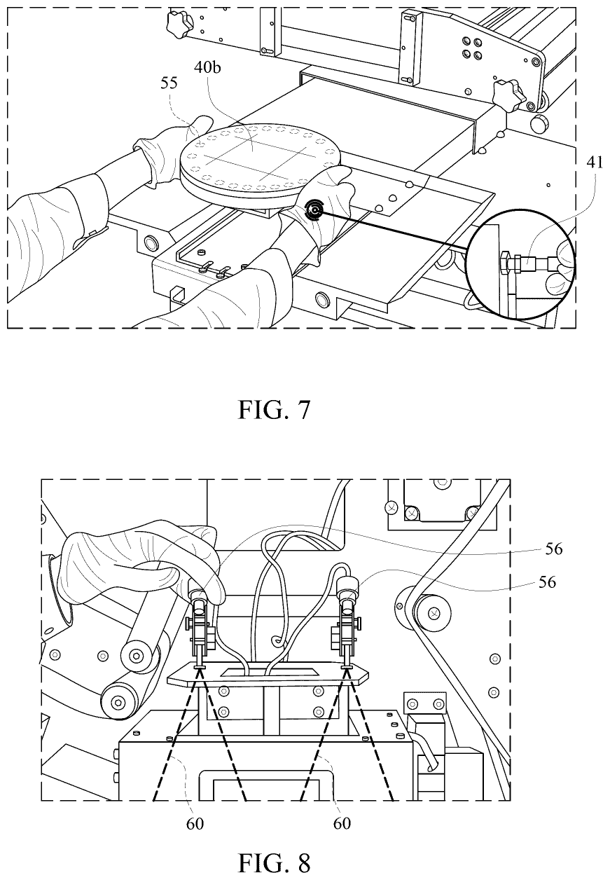

Lower platen 40 is the swappable work surface in that the lower platen 40 is removably attachable to the lower base 38. Lower platen 40 can be locked to lower base 38 using latch 41, enabling quick changeover between different platen shapes. FIGS. 6 and 7 show two examples: square platen 40a for general shirts and a round platen 40b for small or circular articles. The upper face of lower platen 40 may include a silicone layer to improve conformity and friction without stretching fabric.

The lower platen 40 is implemented as a drawer-style platen assembly that can traverse between an in position and an out position relative to the frame of the machine 10. In the out position, the lower platen 40 is extended toward the operator to provide access for loading and aligning a garment 52. In the in position, the lower platen 40 is located directly beneath the upper platen 50 and within the press zone 13 for the transfer operation. The motion of the lower platen 40 between these positions may be accomplished manually or through an electromechanical or pneumatic actuator connected to the lower base 38. The lower platen 40 may further include a throat opening configured to allow the operator to dress a garment 52, such as a shirt, over the platen so that only one layer of the garment lies on the upper surface of the platen while the remaining layer hangs freely below. This arrangement prevents the transfer heat from affecting both sides of the garment and ensures a flat, single-layer pressing surface for accurate transfer placement.

To maintain the shirt's position on the lower platen, vacuum ports 55 may be provided around the periphery of lower platen 40. FIGS. 6 and 7 show vacuum ports 55 placed around the perimeter so vacuum hold-down does not interfere with the pattern 18 when transferred to the garment 52. When the vacuum is turned on, vacuum ports 55 retain garment 52 flat and steady as lower base 38 and the lower platen 40 moves around. Alternatively or additionally, a clamping frame or magnets may be utilized. The frame is wrapped around the periphery of the lower platen after the garment has been properly positioned on the lower platen.

Laser modules 56 project alignment beams 60 to help the operator place the garment 52 consistently on the lower platen. In FIG. 2, the laser modules 56 may be above the lower platen when the lower platen is in the out position. In FIG. 8, the laser modules 56 are shown as being adjustable by hand. This allows the user to adjust the projection of the laser beams 60. The projected beams 60 are illustrated on the lower platen 40 as shown in FIGS. 1-3, 6 and 7. In FIG. 9, the beams 60 are shown overlapping a garment mark 58 on garment 52. The garment mark 58 may be a mark which when they 58 are aligned to the laser beams indicates to the operator that the shirt is properly positioned on the lower platen. The operator adjusts the garment to align the garment mark 58 (for example, a centerline or front-neck datum) to beams 60 for repeatable positioning of the garment on the lower platen. Laser modules 56 should be fitted with simple gimbal mounts for adjusting the beams 60 on the lower platen 40. The laser beams 60 may be turned off when the lower platen is traversed to the in position and may be turned on when the lower platen is traversed to the out position.

Foot pedal 54 provides hands-free actuation of the machine 10. In FIGS. 2 and 3, foot pedal 54 is positioned within easy reach to command the motion of lower base 38 and/or to initiate the press cycle. Upon pressing the foot pedal 54, the lower platen may be traversed to the in position from the out position, and the upper platen may be pressed into the lower platen. An emergency stop button (not shown) on the front panel of machine 10 may be included and works with the foot pedal 54 so that the lower platen and upper platen cannot move if the stop button is engaged.

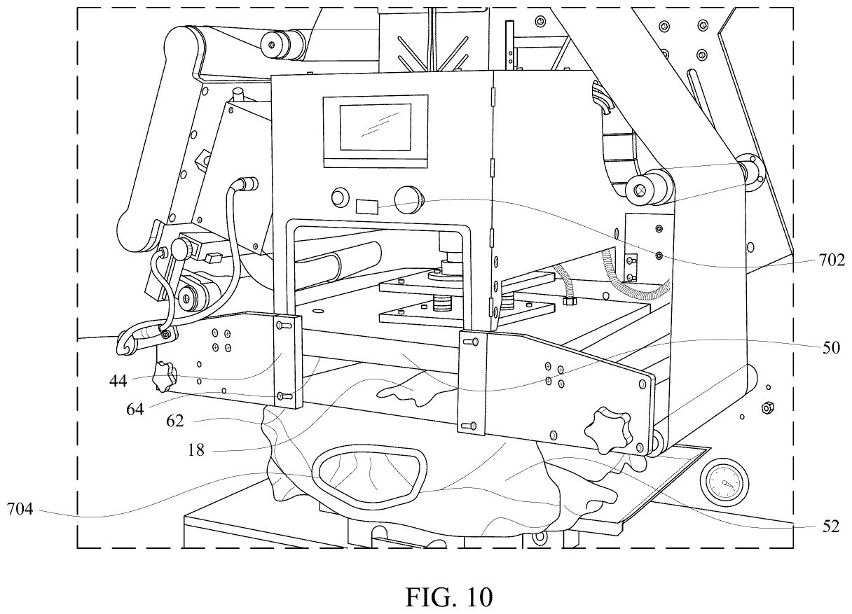

The frame 44 of the machine holds the components of the roll feeding mechanism 69. Moreover, as shown in FIG. 10, the frame 44 surrounds the upper platen. During the pressing cycle, The frame 44 is traversed down first so that the film is at the same level as the upper surface of the lower platen before heat is applied.

Upper platen 50 is heated to a set temperature. The bottom surface of the upper platen 50 defines a heated pressing surface. In FIGS. 10 and 11, upper platen 50 is larger than the pattern 18 so it covers the pattern 18 completely, ensuring uniform temperature and pressure over the pattern 18. Upper platen 50 is temperature-controlled to the set temperature. It is also contemplated that the temperature of the upper platen may be controlled by a temperature sensor that senses a temperature of the garment after the last pressing cycle (i.e., after the pattern 18 has been transferred to the garment). The temperature of the upper platen is adjusted for the next pressing cycle.

After the upper platen presses the pattern 18 on the garment, the upper platen is lifted up. Preferably, the upper platen is lifted up first before the frame. Distance 51 (see FIG. 12) is the initial lift after heating. In FIG. 12, upper platen 50 rises by distance 51 while frame 44 remains and thus the film 16 in the down position. In this position, the film has not yet been peeled off of the pattern 18. The longer the press zone 13 is left in this condition the cooler the pattern becomes before the film is peeled off of the pattern 18. This creates a controlled cooling interval before any peel begins. The peel refers to the film peeling off of the pattern 18. After the selected delay, peel occurs and frame 44 lifts up, as shown in FIG. 13. In FIG. 14, the pattern has been transferred to the garment. This staged sequence—upper platen 50 up by distance 51 first, peel after delay, then frame 44 open—supports hot-peel, warm-peel, and cold-peel processes. The delay may be between 1 second to 1 minute. It is also contemplated that the airflow (i.e., ambient air or cooler than ambient air) may be directed between the upper platen and the garment during the delay to speed warm/cold peels. For example, an air nozzle 724 (optionally adjustable) may be positioned to be disposed between the film and the upper plate as shown in FIG. 12. The air nozzle is a part of a hose 726. The hose 726 may be connected to a blower 728 which blows either ambient air or conditioned air (cooler than ambient) over the top of the film to accelerate the cool down of the heat transfer pattern.

The perimeter 64 of the pattern defines the outline of the pattern 18. In FIG. 10, the perimeter 64 is fully inside the frame 44 so that the frame 44 never touches the active transfer area or even the lower platen. In FIG. 11, upper platen 50 covers image perimeter 64 completely to deliver even pressure and heat. The upper platen maintains pressure on the pattern 18, shirt and the lower platen for a set period of time.

Garment 52 is the workpiece. In FIGS. 8 and 9, garment 52 is placed over lower platen 40, aligned using beams 60 from laser modules 56, and optionally matched to garment mark 58 to ensure consistent placement on the lower platen. Once aligned, garment 52 is held by vacuum ports 55 or a frame clamped to the lower platen so the garment will not shift as lower base 38 moves.

Operating sequence across FIGS. 9-13 is as follows. In FIG. 9, lower base 38 is in the out position, garment 52 is placed on lower platen 40, optionally, beams 60 from laser modules 56 are used to align garment mark 58, and optionally, vacuum ports 55 or frame clamps are engaged to prevent movement of the garment. At this time the print-edge detector at 37 is sensing for leading edge 39 of the next pattern 18 on film 16. In FIG. 10, frame 44 descends first and the film 16 is at same level as the upper surface of the lower platen. In FIG. 11, upper platen 50 presses on the pattern 18, applying a pressure at the set pressure and temperature for the programmed dwell. In FIG. 12, the dwell completes and upper platen 50 lifts up by distance 51 while the film remains at the same level as the upper surface of the lower platen. This starts the controlled cooling interval. In FIG. 13, after the programmed delay, the film is lifted up preferably in a peeling motion to complete the peel of the film off of the heat transfer pattern. In particular, the frame 44 lifts up fully (hence, the film lifts up and peels the film off of the pattern), lower base 38 returns out, and the operator removes garment 52 with the pattern 18 attached to the garment. Moreover, after the film lifts up, a camera 730 (see FIG. 13) may take a picture of the heat transfer pattern after it has been transferred onto the garment. The picture may be analyzed for partial peels, incomplete transfers, misaligned colors, or any other defect in the dtf or heat transfer process. The analysis may be completed by uploading the image to a cloud server or on premise server that has been trained to identify defects via artificial intelligence. If a defect exists, then the cloud server or on prem server may send a signal that a defect exists to the HMI 706. Meanwhile, motors 28a and 28b advance film 16 so the print-edge detector at 37 can sense the next leading edge 39 and stage the next pattern 18 to the right position with respect to the lower platen. Throughout, edge sensor 34 and guide 33 cooperate to properly position the pattern 18 in and out and left to right on the lower platen from cycle to cycle.

The machine 10 may include a human-machine interface (HMI) touchscreen 706 mounted above the press zone 13. The HMI may be configured to store adjustable process parameters 708 as “recipes.” Each recipe 710 may include programmable values for one or more of the following: (1) platen temperature, (2) dwell time, (3) pressing pressure, (4) calibrated film advance distance determined by the print-edge detector 37, (5) lift distance 51 of the upper platen 50, and (6) the peel delay time between lifting upper platen 50 and raising frame 44. The HMI may further include jog buttons 712 for manually rotating motors 28a and 28b in small increments to assist in threading the film 16, and manual centering controls for guide 33 to allow the operator to adjust film tracking when loading or aligning a new roll.

The lower base 38 may be supported on a pair of precision linear guide rails positioned parallel to the direction of motion. Each guide rail may include a carriage block with integral wiper seals to prevent debris from entering the bearing tracks. The linear guides may be mounted to a rigid support plate that is fastened to the main machine frame. The drive mechanism for moving the lower base 38 may be implemented using a pneumatic cylinder, an electromechanical actuator, or any equivalent drive system. In each configuration, the linear guides maintain accurate and parallel movement of the lower platen 40 relative to the upper platen 50 to ensure consistent pressing alignment.

The machine 10 may further include a non-contact infrared temperature sensor positioned above garment 52 and aimed at the center of the transfer region. The temperature sensor may provide a continuous signal to the controller corresponding to the surface temperature of the garment 52. The controller may compare this signal to a programmed target temperature and may terminate the dwell period once the measured surface temperature reaches the desired value. This feedback control arrangement enables consistent transfer performance across garments of varying thickness, materials, and thermal characteristics.

The method of setting up and operating the heat-transfer press machine 10 includes the steps of configuring the system for production, loading the consumable materials, calibrating the alignment systems, and performing the pressing and transfer operation.

The setup process begins by energizing the machine 10. The operator turns on the lockable main disconnect switch mounted on the cabinet and activates the main power switch on the control panel. The controller initializes the HMI, motors 28a and 28b, lower base 38 actuator, guide 33, sensors 34 and 37, and the heating system of upper platen 50. The HMI displays the system status and the current temperature of the upper platen 50. The operator waits until the upper platen 50 reaches its programmed operating temperature before continuing.

The operator selects or enters the process parameters. The HMI may be configured to store multiple recipes containing preset values for platen temperature, pressing pressure, dwell time, lift distance 51, peel delay time, and calibrated film advance distance. The operator may load an existing recipe or manually input parameters suited for the specific film and garment material to be processed.

Next, the operator selects and installs the proper lower platen 40. The shape and size of the lower platen are chosen according to the type of garment or article being printed. For flat garments such as t-shirts or sweatshirts, a square platen 40a may be installed. For small or irregular items, a round platen 40b may be used. The lower platen 40 is attached to lower base 38 using latch 41, ensuring the platen is securely locked in place. The operator verifies that the top surface of lower platen 40 is level and that it will align parallel to the underside of upper platen 50 when in the press position.

The operator then loads the roll of film 16 onto the supply spindle 20a. Roll 14 is mounted so that film 16 unwinds in the correct direction, with the printed surface carrying patterns 18 facing downward toward garment 52 when it passes through the press zone 13. The free end of film 16 is threaded manually through roll feeding mechanism 69, routed around the rollers 30, and attached to the take-up spindle 20b. Motors 28a and 28b are jogged in the forward direction using the jog controls 712 on the HMI until film 16 is properly tensioned and moving smoothly. The difference in speed between the supply and take-up spindles applies a small amount of tension to the film to prevent wrinkles.

After the film is installed, the operator adjusts the edge tracking system to ensure that each printed pattern 18 is correctly aligned vertically on garment 52. The edge sensor 34 is mounted on an adjustable bracket 36 that provides both coarse and fine positional control. To perform the coarse adjustment, the operator loosens a set screw on bracket 36 and slides the entire sensor assembly laterally, either inward or outward, until the printed pattern 18 on film 16 appears approximately at the desired vertical position on garment 52. Once this position is achieved, the operator tightens the set screw to secure bracket 36.

The fine adjustment is then made using thumb wheel 37, which moves the edge sensor 34 incrementally. The operator turns thumb wheel 37 to make minute adjustments, bringing the printed pattern 18 to its exact vertical location on the garment 52. The thumb wheel allows sensitive control over small positional changes without loosening the bracket. After both adjustments are complete, the controller reads the output from edge sensor 34 and records the sensor's position as the vertical reference. During operation, edge sensor 34 continuously monitors the side edge 15 of film 16. If film 16 drifts inward or outward, guide 33 automatically rotates slightly clockwise or counterclockwise to steer the film and maintain this vertical alignment for each cycle.

The print-edge detector 37 is then calibrated to ensure proper left to right placement of pattern 18 on the garment. The operator jogs the film forward until one printed pattern 18 is detected. The controller registers the detection point of leading edge 39 and advances the film by a calibrated distance so that the next pattern 18 will stop in the proper location of the press zone 13. The operator verifies this placement visually or through a test press and, if necessary, fine-tunes the calibrated distance on the HMI until the image appears at the desired front-to-back position on garment 52.

Next, the operator adjusts the laser alignment system. The lower base 38 is moved to the out position, and the laser modules 56 are turned on. Laser beams 60 are projected across the top surface of lower platen 40. Each laser module 56 is adjusted manually to create a crosshair pattern or grid. If available, the garments may have a marker and the lasers are adjusted to corresponds to the desired alignment marks on the garment. The operator aligns the beams so that the crosshair coincides the marker when the garment is properly located on the lower platen. When properly adjusted, these beams act as visual guides for positioning each garment in the same location for every pressing cycle.

With these setup steps complete, the machine is ready for production. The operator moves lower base 38 to the out position using the foot pedal 54 or manually. With lower platen 40 exposed, the operator places garment 52 over the platen surface. If the garment has markers, the markers are aligned to the laser beams. If vacuum ports 55 are provided, the operator activates the vacuum to hold the garment flat. If a clamping frame or magnets are used, they are positioned around the perimeter of garment 52 to keep it taut and prevent shifting of the garment on the lower platen.

Once the garment 52 is properly positioned and secured, the operator may confirm that the pattern 18 is staged above the lower platen. The operator then initiates the press cycle by pressing the foot pedal 54 or start button.

When the cycle begins, lower base 38 moves from the out position into the in position beneath upper platen 50. The movement is guided by precision linear rails that keep the platen parallel and prevent misalignment. Once the lower base 38 reaches its defined stop position, the frame 44 along with the film descends. The frame 44 lowers until film 16 rests substantially at the same level as the top surface of lower platen 40.

After the frame 44 and the film are in position, upper platen 50 lowers and contacts film 16 and garment 52. Upper platen 50 applies heat and pressure for a set time according to the programmed parameters. When the target dwell time is reached, the controller raises upper platen 50 by a predetermined distance 51 while keeping frame 44 lowered. This partial lift separates the heat source while allowing the film and garment to cool gradually without the film being peeled off of the pattern. During this cooling interval, the film remains in contact with the pattern.

After the programmed delay or once the garment surface temperature falls to a specified value, the controller may lift frame 44, and thus the film. As the frame rises, the film 16 peels away from the garment surface, leaving the pattern 18 transferred onto garment 52. Depending on the selected settings, this may occur immediately (hot peel), after a brief pause (warm peel), or after extended cooling (cold peel). Optionally, the system may also direct airflow between upper platen 50 and garment 52 to accelerate cooling when required.

Once the peel is completed, the lower base 38 moves outward to the loading position (i.e., out position). The operator removes the finished garment 52, which now bears the transferred image (i.e., pattern). While the operator unloads, motors 28a and 28b advance film 16 forward. The print-edge detector 37 senses the next leading edge 39, and the controller advances film 16 by the calibrated distance so that the next pattern 18 is automatically staged for the following cycle.

Throughout operation, edge sensor 34 continues to monitor film position, and guide 33 corrects any lateral drift, keeping the vertical placement of the pattern to the garment (i.e., lower platen) consistent.

This process—comprising setup, film threading, alignment calibration, garment placement, pressing, cooling, peeling, and unloading—allows the machine 10 to continuously and automatically transfer patterns 18 from film 16 to garments 52 with accurate registration, consistent pressure and temperature, and repeatable results from cycle to cycle.

Referring now to FIGS. 14-22, the device 110 shown schematically is a multi-station heat-transfer press configured for performing sequential pre-press, transfer, and post-press operations using a single traversing lower platen 140 and two independently heated upper platens 150a and 150b. Device 110 is built upon the same general principles and components described for device 10 in FIGS. 1-13, including a roll feeding system for a DTF film 116 carrying spaced heat-transfer patterns 118, an operator-accessible lower platen that can be moved between an out position and two in positions, and control systems for heating, pressure regulation, and motion. Many components and auxiliary features from the earlier embodiment—such as laser alignment modules, vacuum hold-down ports, or mechanical clamping frames—can be incorporated into device 110 without modification.

Device 110 includes a frame that supports a drawer-style lower platen 140. The lower platen 140 can traverse linearly between an out position, where the platen is accessible to the operator for garment loading and unloading, and multiple in positions, where it is disposed sequentially beneath either the first and second upper platens 150a and 150b. The motion of the lower platen 140 may be powered by an electromechanical actuator or pneumatic cylinder guided, for example, on precision linear rails to maintain planar alignment relative to the upper platens. The lower platen may also include a throat opening allowing a garment 152, such as a shirt, to be placed over the platen so that only one layer rests on the top surface while the other layer hangs freely below, thereby preventing double-layer printing.

The first upper platen 150a and the second upper platen 150b are mounted above the travel path of the lower platen 140 and are spaced apart in the machine frame. Each upper platen defines a heated, flat pressing surface and is vertically movable by its own actuator. Both platens can be controlled independently for temperature, pressure, and dwell time. The first upper platen 150a functions primarily as a pre-press and post-press platen, while the second upper platen 150b performs the transfer pressing operation. Each platen may contain embedded cartridge heaters and thermocouples connected to the controller for closed-loop temperature regulation.

The film 116 is provided either as a roll 114 or as individual sheets carrying the heat-transfer patterns 118. When the roll format is used, the film 116 is advanced by a pair of synchronized electromechanical motors and guiding rollers similar to those described for device 10. The film passes between the second upper platen 150b and the lower platen 140 during the transfer step. The heat-transfer patterns 118 are regularly spaced along the film so that each cycle of advancement positions a single pattern beneath the second upper platen 150b. Edge-sensing, print-edge detection, and guide-rotation features from the first embodiment may be integrated in the same manner to maintain precise registration between the film and garment.

The control system for device 110 may include a central controller and HMI for sequencing the platens and film feed. The same optional laser alignment modules 56 described in FIGS. 1-13 may be mounted on the frame of device 110 to project visible beams onto the surface of lower platen 140 for accurate garment positioning. If provided, the laser system operates identically to that of the earlier embodiment, and any variations in beam pattern or mounting geometry may be implemented as needed.

Operation of device 110 begins with system setup and preparation. The operator energizes the main power supply, allowing the controller to initialize the actuators, heaters, and film-feeding motors. The operator selects or loads the appropriate parameter set on the HMI, specifying temperatures 714 for upper platens 150a and 150b, dwell times, and pressures for the pre-press, transfer, and post-press stages. The desired film advance distance and peel timing may also be programmed if the device includes automated film feeding.

The roll 114 of film 116 is mounted on the supply spindle and threaded through the roller path until it reaches the take-up spindle, as described previously for the single-station device 10. The print-edge detector and edge-alignment system are calibrated to position each pattern 118 correctly when advanced into the transfer station. The operator verifies film tension and alignment before production begins.

The lower platen 140 is then moved to the out position, exposing the loading surface to the operator. A garment 152 is placed over the lower platen 140 so that only the layer to be printed lies on the top surface while the opposite layer hangs beneath the throat of the platen. Laser alignment beams, if installed, are used to align garment marks to ensure that each piece is centered and oriented consistently. The operator may activate a vacuum hold-down or engage a mechanical frame to secure the garment in position.

After the garment is positioned, the operator initiates the cycle. The lower platen 140 first traverses inward to a position beneath the first upper platen 150a. The first upper platen 150a then lowers onto the garment 152 to perform a pre-press operation. During this step, heat and pressure are applied for a short dwell period to remove moisture and flatten wrinkles from the fabric, producing a smooth, dry surface for the transfer. The first upper platen 150a then rises, releasing the garment.

Immediately afterward, the lower platen 140 advances further along its travel path until it is positioned beneath the second upper platen 150b. At this time, the film 116 is advanced so that a heat-transfer pattern 118 is located between the second upper platen 150b and the garment 152 on the lower platen 140. The second upper platen 150b then descends, applying the programmed temperature, pressure, and dwell time to transfer the pattern 118 from the film onto the garment 152. Heat from the platen activates the adhesive layer of the transfer and bonds the image to the textile surface.

Once the transfer dwell time has elapsed, the second upper platen 150b rises. A lifting bar 151 or equivalent mechanism may assist in separating the film 116 from the garment surface by gently lifting or flexing the film upward as the platen rises. In some configurations, the film moves vertically in unison with the upper platen so that when the upper platen lifts, the film peels away from the pattern in a controlled manner. This peeling sequence may be timed or temperature-based, allowing hot, warm, or cold peel cycles as desired.

After the film has separated, the lower platen 140 moves back toward the first upper platen 150a. The shirt 152, now bearing the transferred pattern 118, is positioned beneath the first upper platen 150a for a post-press operation. The first upper platen 150a lowers again and applies heat and pressure to the newly transferred image. This post-press stage ensures complete adhesion and can alter the surface finish of the transfer. A finishing sheet may optionally be placed between the upper platen 150a and the garment during this step to produce a glossy, matte, or textured finish. The sheet can be manually loaded or supplied automatically from a roll using a feed mechanism similar to that used for the DTF film 116.

After the post-press dwell, the first upper platen 150a rises, and the lower platen 140 is moved outward to the loading position. The operator removes the finished garment 152 with the heat-transfer pattern 118 fully applied and replaces it with a new garment for the next cycle. While the operator is unloading and loading garments, the film-feed mechanism advances the film 116 so that the next heat-transfer pattern 118 is staged beneath the second upper platen 150b. The sequence then repeats automatically.

The coordinated motion of the lower platen 140 and upper platens 150a and 150b enables efficient, continuous operation: one garment is being pre-pressed, another is undergoing the transfer, and a third may be unloaded or loaded simultaneously. Because the lower platen travels along a linear path under multiple upper platens, the system eliminates downtime between pre-press, transfer, and post-press operations and maintains consistent temperature and pressure across each stage.

As with the single-station machine 10, device 110 may incorporate optional safety systems such as optical hand sensors or light curtains that detect an operator's presence in the press zone and prevent downward motion of either upper platen when triggered. The same laser alignment, vacuum retention, and film-guiding features described previously can be incorporated here, and all control logic may be integrated into the same HMI interface.

Through this structure and sequence, device 110 performs automated DTF transfers using multiple heated platens while maintaining precise image registration and consistent pressing conditions. The dual-platen configuration increases throughput and allows both pre-and post-press processing without requiring multiple separate machines.

Referring now to FIGS. 23-27, the embodiment illustrated is a side-shifting dual-station heat-transfer press identified as device 210. Device 210 is structurally similar in principle to device 110 described in connection with FIGS. 14-22, but differs in that the lower platen 240 moves laterally from side to side rather than linearly in and out of the machine. The change in direction allows the operator to remain in front of the machine throughout all stages of operation, improving ergonomics and control of garment handling.

Device 210 includes a rigid frame that supports a traversable lower platen 240 mounted on linear guide rails arranged laterally across the front of the frame. The lower platen 240 defines the working surface upon which the garment 252 is placed. The platen may include a throat so that the garment can be placed over it, leaving only one fabric layer on the top surface while the other layer hangs below. Vacuum ports or mechanical clamping frames may be incorporated to hold the garment flat during movement. The lower platen 240 may be driven laterally by an electromechanical actuator, pneumatic cylinder, or manual sliding mechanism equipped with position stops to define the left, center, and right operating stations.

Mounted above the travel path of the lower platen 240 are two vertically movable heated upper platens 250a and 250b. Each upper platen defines a heated pressing surface controlled independently for temperature, pressure, and dwell time. The first upper platen 250a serves as both a pre-press and post-press station, while the second upper platen 250b performs the transfer pressing step. Each platen is supported by its own lift mechanism, such as a pneumatic or electromechanical actuator, connected to the controller for coordinated motion.

Film 216, carrying a plurality of spaced heat-transfer patterns 218, is supplied either as individual sheets or as a roll 214 that is advanced automatically by synchronized motors and guide rollers. The film path passes under the second upper platen 250b so that the heat-transfer pattern 218 on the underside of film 216 is positioned directly between the second upper platen 250b and garment 252 on lower platen 240 during the transfer stage. The same print-edge detection, film-guiding, and peel-timing concepts described for device 10 (FIGS. 1-13) can be applied to this embodiment: upper platen lift precedes film lift by an adjustable interval, enabling hot, warm, or cold-peel operation depending on the film type.

A human-machine interface (HMI) and controller manage heating, timing, and actuator sequencing. The operator may program separate parameter sets for each platen station. The laser alignment system described in the first embodiment may be incorporated into device 210 as well. One or more lasers 56 may project beams 60 onto the surface of lower platen 240 to assist in accurate garment placement. If installed, the laser configuration and adjustment are identical to those previously described. Likewise, safety interlocks, emergency-stop circuits, and guarding around moving or heated components may be provided in the same manner as in device 10 or 110.

Operation of device 210 begins with machine setup. The operator powers the system through the main disconnect, energizes the control system, and waits for both upper platens 250a and 250b to reach their programmed operating temperatures. Using the HMI, the operator selects or creates a processing recipe defining the pre-press, transfer, and post-press temperatures, dwell times, and pressures. If film 216 is provided as a roll 214, it is installed onto the supply spindle and threaded through the guide rollers to the take-up spindle. The film 216 is routed to a position under the second upper platen. The operator calibrates the print-edge detector so that each heat-transfer pattern 218 advances to a centered position under the second upper platen 250b. The edge-sensing and guide-rotation features described for the earlier embodiments may be used here to maintain proper left to right alignment.

With setup complete, the operator moves lower platen 240 to the loading position located laterally outside of both upper platens. A garment 252, such as a shirt, is placed over the lower platen so that only one fabric layer rests on the top surface and the opposite layer hangs below the throat. The garment is flattened by hand and optionally secured using vacuum suction or a clamping frame. If laser beams 60 are present, the operator aligns a garment mark 58 (for example, a centerline or neckline datum) with the projected beams to ensure consistent positioning. The neckline datum is that of the collar of a shirt.

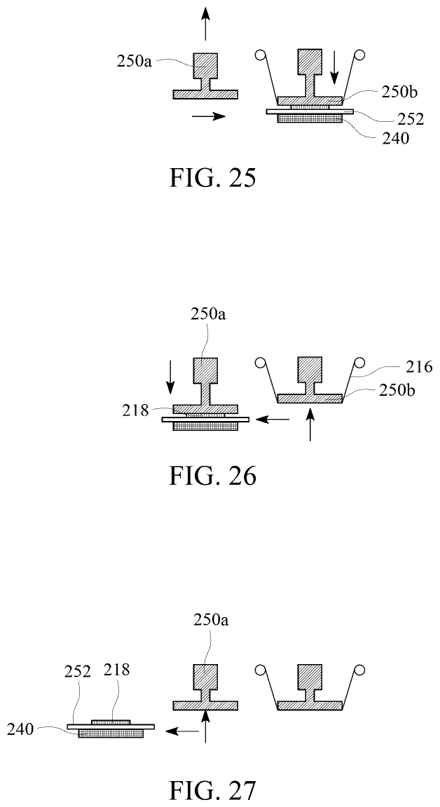

Once the garment 252 is positioned, the operator initiates the cycle. The lower platen 240 traverses laterally beneath the first upper platen 250a (see FIG. 24). The first upper platen 250a then descends and applies heat and pressure to the garment for a short dwell period to pre-press the fabric. This step removes moisture and wrinkles, creating a smooth and dry surface for transfer. After the dwell time expires, the first upper platen 250a rises, and the lower platen 240 shifts laterally (see FIG. 25) until it is positioned directly beneath the second upper platen 250b.

When the lower platen 240 reaches the transfer station (i.e., second upper platen), the controller confirms that a fresh section of film 216 with a heat-transfer pattern 218 is staged above the lower platen. The second upper platen 250b then descends to press the film 216 and pattern 218 against the garment 252, as shown in FIG. 25. The applied heat and pressure bond the transfer pattern to the garment. After the programmed dwell time, the second upper platen 250b lifts upward by a predetermined distance while the film remains momentarily in contact with the garment. The controller holds this intermediate position for a delay period—typically between one and one minutes, and preferably between 7 to 10 seconds—to allow partial cooling of the transfer. The delay duration determines whether the process functions as a hot, warm, or cold peel. After the delay, the film is lifted or peeled away, completing the transfer.

Following the transfer step, the upper platen is traversed fully upward as shown in FIG. 26. Moreover, the lower platen 240 traverses laterally back under the first upper platen 250a for the post-press operation as shown in FIG. 26. The first upper platen 250a lowers again to apply finishing heat and pressure to the freshly transferred image, as shown in FIG. 26. A finishing sheet may optionally be inserted between the platen and the garment to impart a desired surface effect such as matte, glossy, or textured finish. The sheet may be manually placed or dispensed automatically from a roll. If by a roll, the roll feeding mechanism discussed herein for the film may be utilized and placed on the first upper platen location. After the post-press dwell, the first upper platen 250a rises, as shown in FIG. 27.

The lower platen 240 then slides laterally back to the loading position (see FIG. 27), bringing the garment 252 within easy reach of the operator. The operator removes the finished garment, now bearing the heat-transfer pattern 218, and places a new garment on the lower platen for the next pressing cycle. While the operator is unloading and reloading, the film-feeding mechanism automatically advances the film 216 so that the next heat-transfer pattern 218 is centered beneath the second upper platen 250b. Also, the roll used for post pressing may be advanced too. The sequence then repeats continuously.

Because the lower platen 240 moves laterally instead of in and out, the operator remains in front of the machine throughout setup and operation. This arrangement improves workflow, visibility, and safety by minimizing operator reach. If an error occurs during the heat transfer press operation, the operator can stop the machine and fix the issue. The machine may include optional safety sensors to detect the presence of hands or obstructions in the press zone and prevent downward motion of the upper platens. The laser alignment, vacuum retention, film-guiding, and heater-lift/film-lift timing features from the earlier embodiments may all be implemented in device 210.

Through this configuration, device 210 provides the same functional capabilities as the in-out system of FIGS. 14-22 while offering a compact lateral-motion layout that maintains full access to the working area. The coordinated operation of the pre-press platen 250a, transfer platen 250b, and side-sliding lower platen 240 allows efficient, repeatable transfer of designs from film 216 to garments 252 with precise alignment, controlled temperature, and selectable peel timing.

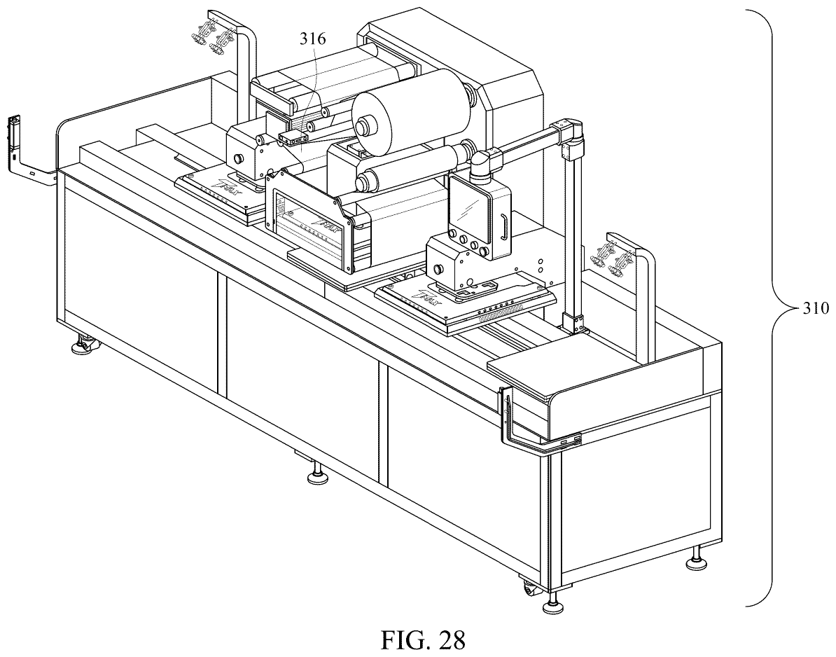

The embodiment shown in FIGS. 28-33 illustrates a dual-station or “two-up” semi-automatic direct-to-film (DTF) heat-transfer press machine 310 configured for simultaneous garment preparation and transfer operations. Machine 310 shares many of the structural and functional features described with respect to the single-station machine 10 of FIGS. 1-13, including a roll-feeding mechanism 69 for guiding a film 316 carrying spaced heat-transfer patterns 318, upper heated platens, lower platens that support garments, and alignment features such as sensors and lasers. Unless otherwise stated, components having the same function as those previously described operate in substantially the same manner. In this embodiment, two lower platens 340a and 340b translate laterally in unison (synchronized to each other) so that one platen may be accessible to the operator while the other is positioned under a central heat-transfer station.

Machine 310 includes three upper platens 350a, 350b, and 350c arranged horizontally across the frame. The left upper platen 350a serves as a pre-press that removes wrinkles and moisture from a shirt 352a prior to transfer and post press that levels and finishes the transferred image (i.e., pattern). The middle upper platen 350b serves as the transfer station for both sides where the heat-transfer pattern 318 on film 316 is applied to a shirt 352b (i.e., garment). The right upper platen 350c serves as a pre-press that removes wrinkles and moisture from a shirt 352b prior to transfer and post press that levels and finishes the transferred image (i.e., pattern). Each upper platen is independently heated and vertically actuatable by pneumatic or electromechanical drives under the control of a programmable controller. The roll of DTF film 316 is guided by a series of rollers and tensioning elements similar to those described for film 16 in FIGS. 1-13 so that the printed pattern 318 is sequentially advanced beneath the middle upper platen 350b between successive transfer cycles.

The two lower platens 340a and 340b are mechanically linked so that they move in synchronized unison—when one platen moves toward the left, the other moves an equal distance toward the left. Each platen is mounted on a linear guide and driven by a common actuator or synchronized dual-motor drive to ensure precise, repeatable motion. Both platens include upper work surfaces that may incorporate vacuum ports, mechanical frames, or magnetic clamps to retain the garment in position during traversal of the lower platens, as previously described with respect to lower platen 40 of FIGS. 6 and 7. Each platen may also have a throat region so that only the upper fabric layer of a shirt rests on the platen surface while the remainder hangs freely below, preventing transfer marks.

Laser alignment modules 56 of the type previously described may be incorporated on both sides of machine 310. The left and right lasers project beams 60 onto the upper surfaces of the corresponding lower platens 340a and 340b to assist the operator in positioning shirts 352a and 352b on the lower platens when they are transitioned to the loading positions. These lasers may be adjustable to mark a reference corresponding to the desired alignment of the printed pattern 318 on the garment. The same laser features described for FIGS. 1-13 can be employed here, or alternative laser arrangements can be used to project independent patterns for each platen.

At the beginning of operation, one of the lower platens 340a and 340b are positioned at its outermost location, fully accessible to the operator. The operator places a first shirt 352a on the first lower platen 340a. Alignment of each garment is performed with the aid of the respective laser beams 60. The film 316 is threaded through the roll-feeding mechanism and advanced so that a first printed pattern 318 is positioned beneath the middle upper platen 350b. The controller is programmed with the dwell times, temperatures, and pressures for the pre-press, transfer, and post-press stations. Each upper platen 350a-350c is preheated to its target temperature before production begins.

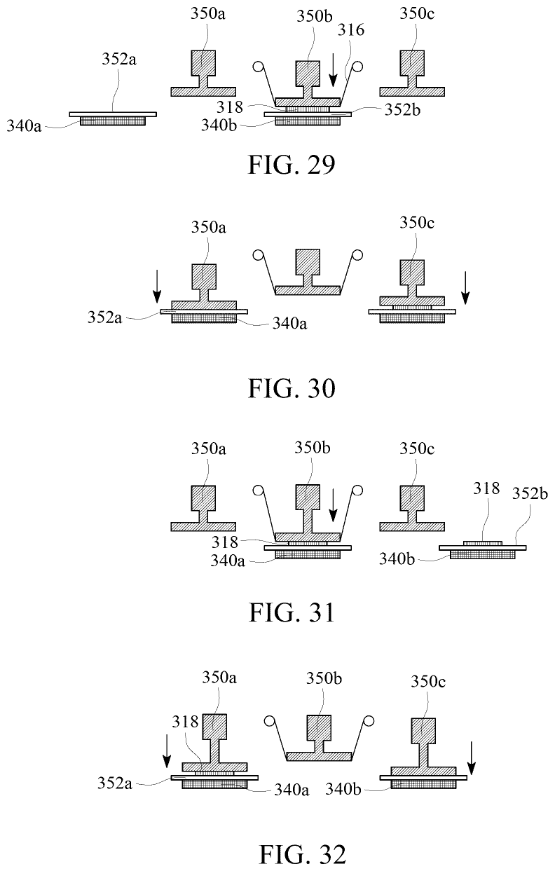

Operation proceeds as a coordinated, cyclic process. Referring to FIG. 29, the first lower platen 340a bearing shirt 352a is in the load position, and the second lower platen 340b is positioned beneath the middle upper platen 350b where the heat transfer is in progress. The middle upper platen 350b applies heat and pressure to bond the heat-transfer pattern 318 to the shirt 352b. After the dwell interval elapses, the upper platen 350b is lifted, allowing controlled cooling of the pattern before the film 316 is peeled away. While this transfer occurs, the operator may load or unload the opposite platen.

During the first cycle, the second upper platen is in the up position. Only after the first cycle does the second upper platen traverse up and down. The situation above describes the cycle after the first cycle has been completed.

As shown in FIG. 30, once the transfer cycle ends, the left upper platen 350a descends to pre-press the newly loaded shirt 352a on the first lower platen 340a, flattening wrinkles and removing moisture. Simultaneously, if a shirt 352b was previously pressed in the middle station, the right upper platen 350c may descend to post-press the transferred pattern, applying additional heat and pressure to level the ink and improve adhesion. Each platen operates under independent timing control managed by the controller.

After both the pre-press and post-press steps complete, the left and right upper platens 350a and 350c raise (FIG. 31). The synchronized actuator translates both lower platens 340a, 340b laterally so that the pre-pressed shirt 352a moves under the middle upper platen 350b and the finished shirt 352b moves to the unloading position. The operator removes the finished garment 352b and, if desired, places a new blank shirt 352b on the now-accessible second lower platen 340b (FIG. 31).

Next, the middle upper platen 350b descends onto the first shirt 352a and the newly advanced heat-transfer pattern 318 (FIG. 31). Heat and pressure are applied for the programmed dwell time, while the film tension and timing are maintained by the coordinated motion of the supply and take-up spindles, as previously described in the single-station embodiment. Upon completion, the upper platen 350b lifts and the controller delays peeling of the film 316 for a user-set period to allow hot-, warm-, or cold-peel operation. During this delay, optional forced-air cooling may be directed onto the transfer zone to accelerate cooling.

As shown in FIG. 33, the lower platens 340a, 340b then shift again so that the newly transferred shirt 352a moves under the left upper platen 350a for post-pressing, and the newly loaded shirt 352b moves under the right upper platen 350c for pre-pressing. The upper platens 350a, 350c are traversed down. The upper platens 350a, 350c are tranversed upward. The lower platents 340a, b are traversed to the side so that the garment on the lower platen 340a is in the unloading position. The upper platen 350b is traversed downward to heat press the pattern on the new garment 352b. The process repeats in alternating fashion, allowing continuous production with one operator alternately loading and unloading garments from each side. The user needs to shift from the left side to the right side then back again. Or, two operators can be used to transfer the garments on each of the left and right sides.

This embodiment can incorporate any of the auxiliary features disclosed in the prior embodiments, including safety sensors that prevent closure of the upper platens when the operator's hands are detected near the press zone,

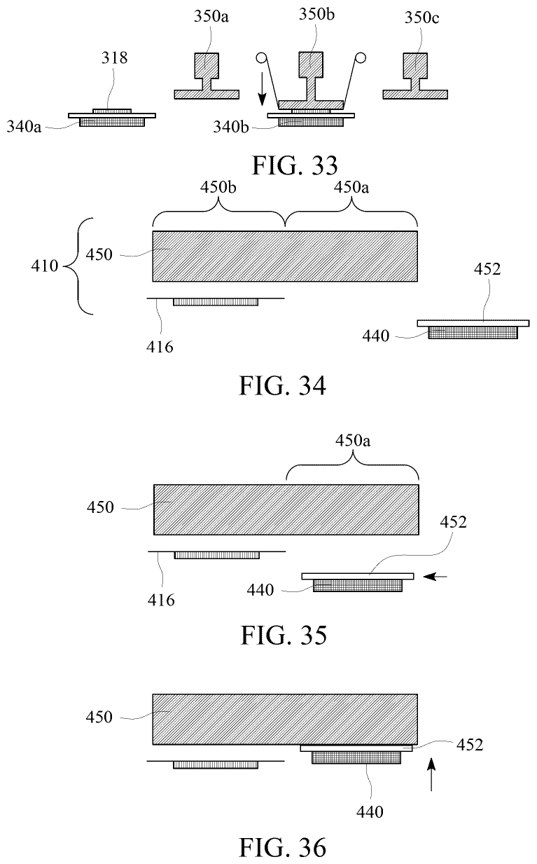

Referring now to FIGS. 34-42, the device 410 is a single-station, dual-zone heat-transfer press designed for direct-to-film (DTF) operations in which a single elongated upper platen 450 remains stationary while a lower platen 440 moves both horizontally and vertically beneath it. Device 410 operates on the same fundamental principles as the machine 10 described in FIGS. 1-13 and may include the same roll-feeding mechanism 69, edge sensor 34, print-edge detector 37, and guide 33 described therein. Unless otherwise stated, the components bearing identical reference numbers perform the same functions as previously described.

Referring now to FIG. 34, device 410 includes a rigid frame supporting the upper platen 450 and a movable lower platen 440. The upper platen 450 extends laterally across the width of the machine and is divided into at least two functional regions—a first side portion 450a used for pre-pressing and post-pressing and a second side portion 450b used for transferring the heat-transfer pattern 418 from the DTF film 416 to the garment 452. The upper platen 450 defines a heated flat pressing surface having embedded electrical heating elements and temperature sensors for closed-loop temperature control. Each side portion 450a, 450b can be controlled independently through the main controller, allowing the first portion to operate at a different temperature than the second portion to optimize pre-press and transfer steps.

The lower platen 440 defines a flat, heat-resistant work surface and is mounted to a powered carriage configured for both horizontal translation and vertical movement relative to the upper platen 450. The horizontal translation may be guided by precision linear rails extending along the machine frame, while the vertical motion may be driven by an electromechanical or pneumatic lift mechanism. The controller coordinates both axes of movement so that the lower platen 440 can traverse between several distinct positions: an “out” position accessible to the operator for loading and unloading garments, a first “in” position under the first side 450a for pre-pressing, and a second “in” position under the second side 450b for heat transfer and post-pressing operations.

As in the prior embodiments, the lower platen 440 may include a throat that allows a shirt or similar garment 452 to be dressed over the platen so that only one layer lies on the pressing surface while the opposite layer hangs freely below. This configuration prevents the transfer heat from affecting both sides of the garment and provides a flat, single-layer pressing surface for accurate transfer placement. The upper surface of the platen 440 may include a silicone cover to distribute pressure evenly and increase friction with the garment. All other embodiments disclosed herein may have a silicon cover as a part of the lower platen. Optional vacuum ports 55 or a mechanical frame may be incorporated around the platen's periphery to hold the garment flat during movement, as previously described in connection with FIGS. 1-13.

A roll of DTF film 416 carrying multiple spaced heat-transfer patterns 418 is supported by a roll-feeding mechanism 69 of the same general design discussed earlier. The mechanism 69 includes supply and take-up spindles 20a and 20b, electromechanical motors 28a and 28b, and guide rollers 30 that maintain tension and direct the film path through the transfer zone. The motors are operated such that the take-up motor 28b runs at a slightly higher surface speed than the supply motor 28a, establishing a steady tension across the film. A steerable guide 33 and edge sensor 34 are used to maintain proper lateral alignment of the film as it advances. The print-edge detector 37 identifies the leading edge 39 of each heat-transfer pattern 418 and commands the controller to advance the film by a calibrated distance so that the pattern 418 is centered over the garment 452 when the lower platen 440 reaches the transfer position. Because all three of these subsystems—guide 33, sensor 34, and detector 37—operate identically to those described in FIGS. 1-13, their operation is not repeated in detail here.

Device 410 may also include laser alignment modules 56 positioned above the lower platen 440 to project one or more laser beams 60 across its surface to aid the operator in positioning the garment. These lasers may be identical to those described in FIGS. 1-13 and may be calibrated such that the projected beam lines correspond to garment alignment marks 58. The laser system can be automatically deactivated when the platen 440 is under the upper platen 450 and reactivated when it returns to the loading position. All laser variations described previously can be incorporated directly into device 410.

Setup of the device 410 begins with powering on the system and allowing the upper platen 450 to reach its programmed temperature setpoints. The controller initializes all motion and heating systems, including the lower platen actuators, roll-feeding motors 28a, 28b, sensors 34 and 37, and the laser modules 56. Through a human-machine interface (HMI), the operator selects or loads a recipe specifying temperatures for the pre-press, transfer, and post-press stages; dwell times; pressures; lift distances; and peel delay intervals. Once the parameters are confirmed, the operator threads the roll 414 of film 416 through the roll-feeding mechanism 69, wrapping it around the guide rollers 30 and attaching it to the take-up spindle 20b. The motors are jogged to establish film tension, and the operator uses thumb wheel 37 and bracket 36 to align the edge sensor 34 with the side edge 15 of the film 416 so that the vertical placement of the pattern 418 is consistent.

After setup, the operator moves the lower platen 440 to the loading position as shown in FIG. 34. A garment 452, such as a shirt, is placed over the platen, with only the top layer resting on its upper surface. If provided, the vacuum ports 55 are activated or the mechanical frame is engaged to secure the garment. The operator aligns a garment mark 58 (for example, the neckline datum) with the projected laser beams 60 to ensure that the garment is centered. When properly positioned, the operator initiates the press cycle using the foot pedal 54 or start button.

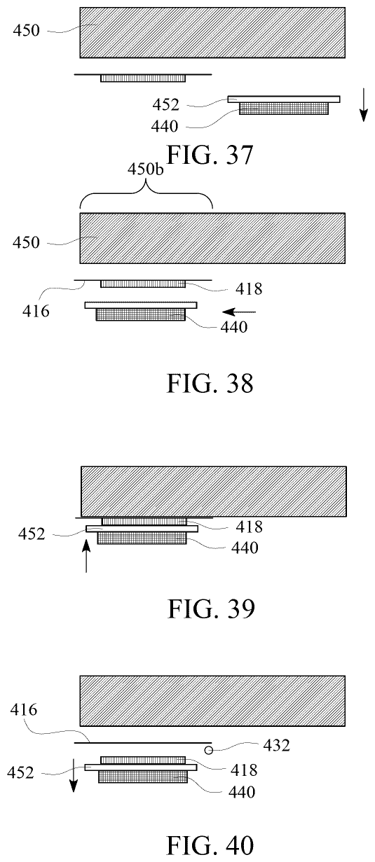

The controller commands the lower platen 440 to move horizontally under the first portion 450a of the upper platen 450, as shown in FIG. 35. Once in position, the lower platen 440 moves vertically upward (FIG. 36) to press the garment 452 against the heated surface of the upper platen 450a for a short dwell period. This pre-press operation removes moisture and wrinkles from the garment, producing a smooth and dry surface for the subsequent transfer step. After the pre-press dwell, the lower platen 440 lowers (FIG. 37) and traverses laterally under the second portion 450b of the upper platen 450 (FIG. 38). At this point, the roll-feeding mechanism 69 advances the film 416 so that one heat-transfer pattern 418 is located between the garment 452 and the upper platen 450b.

Once the film 416 and garment 452 are properly positioned, the lower platen 440 raises upward (FIG. 39) to press the garment, film, and heat-transfer pattern 418 against the heated underside of the upper platen 450b. The heat activates the adhesive layer of the transfer, bonding the pattern 418 to the garment 452. After the programmed dwell time, the lower platen 440 descends slightly to separate the film from the upper platen to create a cooling interval, while a holding bar 432 (see FIG. 40) or equivalent mechanism retains the film 416 in its elevated position, as shown in FIG. 40. The vertical separation between the upper platen and stationary film produces a controlled peel—hot or warm—depending on the selected delay time between 1 and 60 seconds, and more preferably 7 to 10 seconds. This controlled-timing separation of platen lift and film peel is an optional key advantage of the machine.

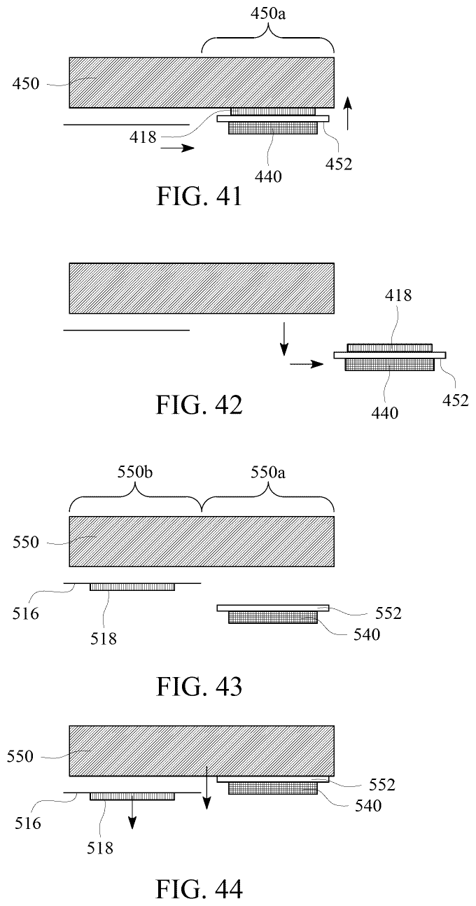

After the peel stage, the lower platen 440 traverses laterally back beneath the first side 450a of the upper platen 450, as shown in FIG. 41. The platen 440 then rises again for a post-press operation in which moderate heat and pressure are applied for a short dwell period to ensure full adhesion of the transfer and improve surface finish. A finishing sheet may optionally be placed between the garment and upper platen 450a to produce a desired texture, gloss, or matte appearance. The finishing sheet may be inserted manually or by provided in a roll form and fed under such portion via a second roll feed mechanism. After post-pressing, the lower platen 440 lowers and moves outward to the loading position (FIG. 42), where the operator removes the finished garment 452 and loads the next piece.

Throughout this sequence, the control system maintains synchronization of all movements, including the lower platen's horizontal and vertical travel, the roll-feed advance, and the timed lifting of the film 416. Safety sensors may be included at the front of the machine to detect the operator's hands and inhibit platen motion if triggered. All auxiliary systems described in connection with the earlier embodiments—such as vacuum hold-down, mechanical clamping, and laser alignment—can be integrated into device 410 as appropriate.

The device 410 thus combines pre-press, transfer, and post-press functions under a single elongated upper platen 450 while utilizing a dual-axis movable lower platen 440 to perform each stage in sequence. This configuration simplifies construction, reduces footprint, and maintains the precision alignment and peel-timing benefits described in the earlier embodiments.

Referring now to FIGS. 43-52, the device 510 is a direct-to-film (DTF) heat-transfer press similar in function to the machine 410 of FIGS. 34-42, except that in this embodiment the lower platen 540 moves horizontally while the upper platen 550 moves vertically during pressing and peeling operations. The device 510 operates on the same general principles described for the machine 10 in FIGS. 1-13, with the same system of roll feeding, pattern alignment, and peel-timing control. Components bearing the same reference numerals perform the same functions unless otherwise specified.

Referring now to FIG. 43, device 510 includes a rigid frame supporting the vertically movable upper platen 550 and the horizontally movable lower platen 540. The upper platen 550 defines a heated pressing surface that can be temperature-controlled by internal electrical heaters and thermocouples connected to the main controller. The upper platen 550 may be divided into distinct zones—such as a pre-press region 550 a and a post-press region 550b—that can be operated at different temperatures if desired. The lower platen 540 is a drawer-style platen assembly that slides horizontally between a loading position, accessible to the operator, and two in positions directly beneath the upper platen 550.

The lower platen 540 defines a flat pressing surface and may include a silicone top layer (e.g., cover) to ensure uniform pressure and to prevent slippage of the garment 552 during pressing. A throat region may be defined beneath the platen so that the garment 552, such as a shirt, can be placed over the platen, leaving only the top fabric layer on the pressing surface while the opposite layer hangs freely below. This configuration prevents unintended heat exposure to the underside of the garment. The garment 552 can be held in place using vacuum ports 55 located around the periphery of the lower platen, or alternatively by a mechanical clamping frame or magnets distributed along the outer edge.

A roll of film 516 carrying spaced heat-transfer patterns 518 is mounted on a roll-feeding mechanism 69 identical to that described for FIGS. 1-13. The mechanism is located at the second portion 550b. The mechanism includes supply spindle 20a, take-up spindle 20b, tension rollers 30, and electromechanical motors 28a and 28b. Motor 28a releases the film from the roll, while motor 28b collects the used film after transfer. The two motors may operate at slightly different surface speeds to maintain tension in the film. The film path carries the film 516 between the upper platen 550 and the lower platen 540 during the transfer stage. An edge sensor 34 and steerable guide 33 maintain lateral alignment of the film 516, while a print-edge detector 37 identifies the leading edge 39 of each heat-transfer pattern 518 and signals the controller to advance the film a calibrated distance so that the pattern 518 is centered over the garment 552.

As in prior embodiments, one or more laser modules 56 may be installed above the lower platen 540 to project visible laser beams 60 across its surface. These lasers assist the operator in aligning the garment 552 using alignment marks 58, such as a neck or centerline datum. The laser configuration can be identical to that described for the single-station machine 10, and its projection geometry may be adjusted as required. All optional laser, vacuum, and mechanical retention features previously described can be incorporated directly into device 510.

The upper platen 550 is vertically movable and driven by an actuator system, such as an electromechanical or pneumatic cylinder, mounted within the frame. The actuator provides a controlled downward pressing force at a predetermined temperature and pressure. The lift height, dwell time, and pressing force are programmable via the human-machine interface (HMI). The motion of the upper platen 550 may be monitored by linear position sensors to ensure repeatable travel between cycles.

The lower platen 540 is driven horizontally by an electromechanical actuator, such as a stepper motor or servo motor with a linear guide rail. The actuator moves the lower platen between its loading position, where the garment 552 can be loaded and unloaded by the operator, and its two in positions directly beneath the upper platen 550. The travel limits are monitored by position sensors or adjustable stoppers to ensure accurate placement.

Device 510 may include a controller that synchronizes the operation of the upper platen 550, lower platen 540, and roll-feeding mechanism 69. The controller executes timed sequences in which the upper platen 550 lifts first, creating a controlled cooling interval, followed by delayed peeling of the film 516. This timed separation—preferably adjustable between 1 and 10 seconds—permits hot-peel, warm-peel, and cold-peel cycles.

The setup procedure for device 510 is as follows. The operator first energizes the system using the lockable main disconnect switch, then powers the control panel and allows the upper platen 550 to reach its programmed temperature setpoint. Using the HMI, the operator loads a recipe defining platen temperatures, dwell times, peel delays, and film advance distances. The roll of film 516 is installed on the supply spindle 20a, threaded through rollers 30, and attached to take-up spindle 20b. Motors 28a and 28b are jogged to tension the film. The edge sensor 34 is adjusted using bracket 36 and thumb wheel 37 so that the side edge 15 of the film 516 is aligned with the sensor beam. The print-edge detector 37 is calibrated by detecting the leading edge 39 of one pattern 518 and advancing the film until the pattern is centered beneath the pressing area of upper platen 550.

Once setup is complete, the operator moves the lower platen 540 to the out position and places a garment 552 over the platen, aligning its garment mark 58 with the projected laser beams 60. If provided, the vacuum system is activated or the mechanical frame engaged to secure the garment. The operator then initiates the pre-press cycle by pressing the foot pedal 54 or start button.

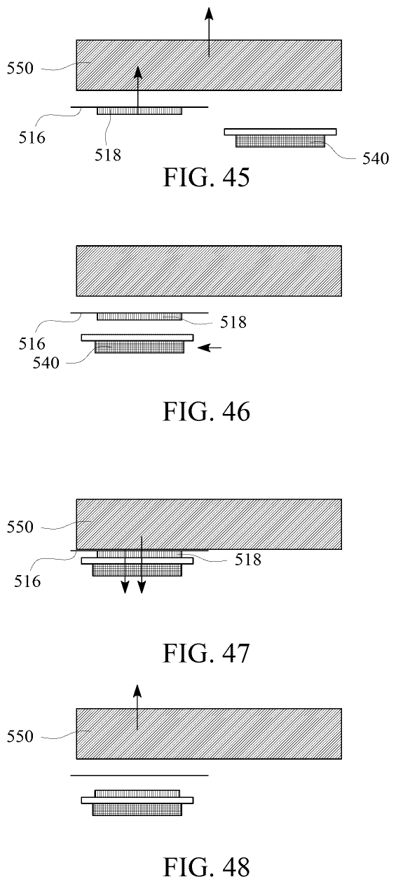

In FIG. 43, the lower platen 540 is positioned under the upper platen 550 for pre-pressing. The controller lowers the upper platen 550 (FIG. 44) to press the garment 552 for a short dwell period, applying moderate heat and pressure to remove moisture and flatten wrinkles. The upper platen 550 then lifts (FIG. 45), and the film 516 along with the roll-feeding mechanism 69 moves upward simultaneously, providing clearance for the lower platen 540 to translate beneath it.

The lower platen 540 then moves horizontally under the roll-feeding mechanism 69 (FIG. 46). The upper platen 550 descends again (FIG. 47) to press the heat-transfer pattern 518, film 516, and garment 552 together for a programmed dwell period, at a defined pressure and temperature. The heat activates the adhesive layer of the transfer, bonding the pattern 518 to the garment 552.

After the dwell interval, the upper platen 550 lifts vertically (FIG. 48) by a defined distance while maintaining the film 516 in its lowered position. This partial lift begins the cooling interval without peeling the film away. The film 516 remains in contact with the garment 552 for a programmed time delay—typically 1 to 60 seconds, and more preferably 7 seconds to 10 seconds—to allow the transferred image to cool and stabilize. After the delay, the roll-feeding mechanism 69 lifts the film 516 upward, peeling it away from the garment surface in a controlled manner. The upper platen 550 may simultaneously direct airflow across the press zone to accelerate cooling for warm or cold peels.

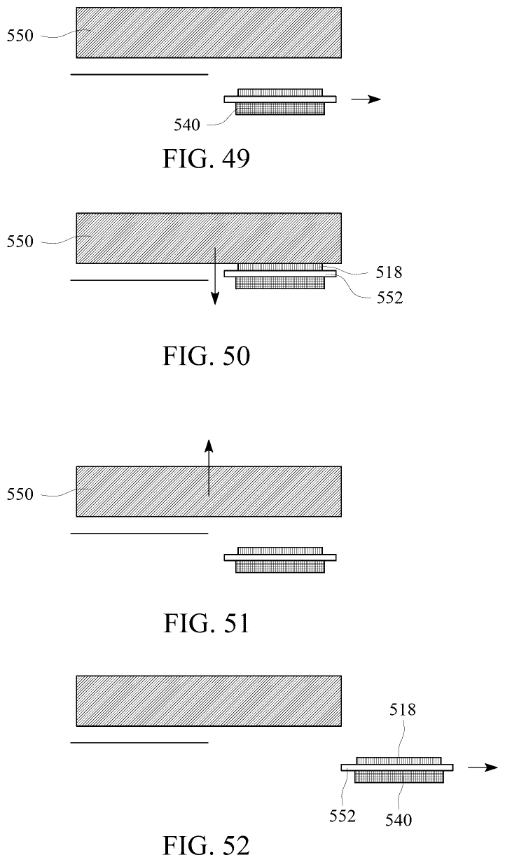

The lower platen 540 then moves horizontally to the side (FIG. 49) so that the shirt 552 and transfer pattern 518 are positioned under a first side portion of the upper platen 550, where post-pressing occurs. The upper platen 550 lowers again (FIG. 50) to apply moderate heat and pressure to the garment 552 and newly transferred pattern 518, completing the post-press operation. This step improves adhesion, smooths the transferred image, and can be used to apply a matte or gloss finish depending on the optional finishing sheet used between the platen and garment.

After the post-press dwell, the upper platen 550 rises (FIG. 51), and the lower platen 540 returns to the loading/unloading position (FIG. 52). The operator removes the finished garment 552 and loads a new one, repeating the process.

All auxiliary systems described in previous embodiments—such as edge detection, print-edge calibration, adjustable peel delay, and safety sensors preventing downward platen movement when hands or obstructions are detected—may be incorporated into device 510. The laser alignment system described in connection with FIGS. 1-13 may also be integrated, except for its mounting location above the lower platen 540.

The embodiment of FIGS. 43-52 therefore provides a configuration in which the upper platen 550 moves vertically to perform the pressing and peeling sequence while the lower platen 540 moves horizontally to load, pre-press, transfer, and post-press garments. This arrangement simplifies the mechanical drive system, reduces space requirements, and preserves all key functional advantages described for the earlier embodiments, including accurate pattern registration, selectable peel timing, and compatibility with various garment materials and DTF films.

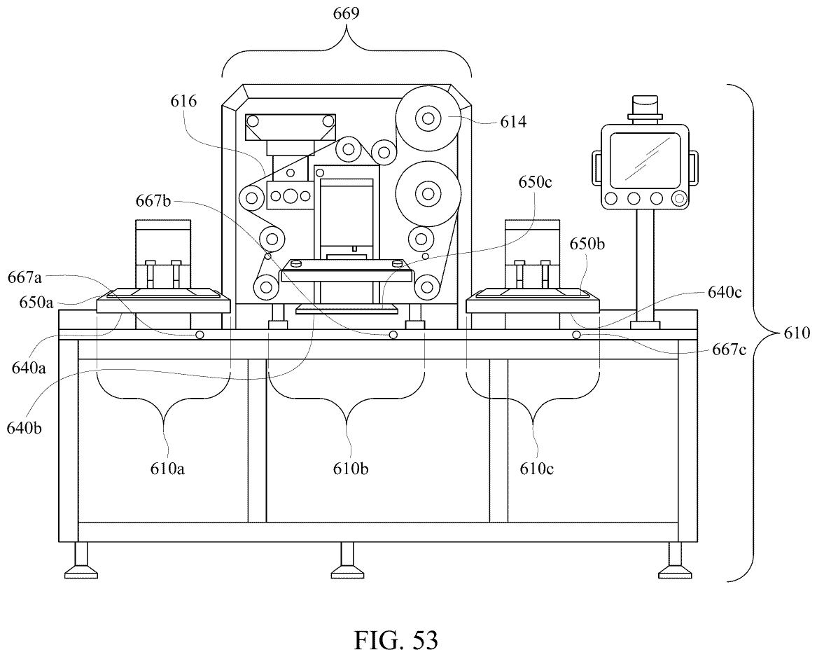

Referring now to FIG. 53, the device 610 is a multi-station heat-transfer system designed to maximize throughput for direct-to-film (DTF) heat transfers. Each station 610a, 610b, and 610c of the device 610 functions as an independent heat press equipped with an upper platen 650 and a corresponding lower platen 640. The upper platen 650 of each press moves vertically, while the lower platen 640 moves horizontally between an in position beneath the upper platen 650 and an out position (i.e., loading position) where it is accessible to the operator so that the operator can place a shirt on the lower platen or remove the worked on shirt. The overall function of each station corresponds to the operations described for the devices of FIGS. 1-13, 14-22, and 43-52, except that in this embodiment, multiple presses operate in parallel under the control of a central operator.

The frame of the machine supports three distinct press assemblies arranged in sequence around a common working area. Each press assembly includes a heated upper platen 650a, b, c defining a flat pressing surface, and an associated lower platen 640a, b, c mounted on a sliding carriage guided by linear rails. The upper platens 650a, 650b, and 650c are heated by internal electrical elements and controlled by independent temperature regulators. Each lower platen 640a, 640b, and 640c defines a silicone-covered work surface sized for a single garment 652 and may include a throat region allowing the garment to be placed over the platen so that only the top layer of fabric lies on the surface while the opposite layer hangs freely below.

Each lower platen 640 can traverse between an in position, directly below its corresponding upper platen 650, and an out position, forward of the upper platen, where the operator can access it to load and unload garments. The motion of each lower platen 640 may be powered by an electromechanical actuator, such as a stepper or servo motor, or alternatively by a pneumatic cylinder. It may also be manual operation. Position sensors or adjustable stoppers ensure precise repeatability between cycles. The upper platen 650 in each station is vertically movable by its own actuator system and applies heat and pressure for a controlled dwell time, pressure, and temperature.

The first heat press 610a serves primarily as a pre-press station. The purpose of the pre-press operation is to remove moisture from the garment 652 and flatten wrinkles before transfer. The second heat press 610b serves as the transfer station and includes a roll-feeding mechanism 669 supporting a roll 614 of DTF film 616 carrying spaced heat-transfer patterns 618. The third heat press 610c serves as a post-press station for finishing the garment after the transfer has been completed.

Each press 610 (especially the middle station or transfer station) may be equipped with one or more laser modules 656 projecting alignment beams 660 onto the surface of the lower platen 640 to assist the operator in positioning garments. The lasers 656 may be the same as those described in the embodiment of FIGS. 1-13 and can be calibrated to align with garment marks 658, such as a neckline or centerline datum. Preferably, the transfer station 610b includes the alignment lasers, since alignment accuracy is most critical during the transfer stage. Optional vacuum ports or mechanical frame clamps can be provided around each lower platen 640 to hold the garment flat during pressing, as described earlier.

The system may also include safety sensors such as optical detectors or proximity switches at each station to ensure that the upper platen 650 cannot descend while the operator's hands or tools are detected within the pressing zone. These safety systems may be tied into a common controller that synchronizes the operation of the three presses. Each press 610 has a dedicated start button 667a, 667b, or 667c that allows independent activation of its respective cycle.

Operation of the device 610 begins with all upper platens 650 in their raised positions and all lower platens 640 in their out positions. The operator first loads a garment 652 onto the lower platen 640a of the first press 610a. Once positioned, the operator may press the first start button 667a. The lower platen 640a moves into its in position beneath the first upper platen 650a. The upper platen 650a then descends to perform the pre-press operation, applying moderate heat and pressure for a short dwell time to remove moisture and wrinkles from the garment. After the dwell time elapses, the upper platen 650a rises, and the lower platen 640a returns to the out position where it can be unloaded.

The pre-pressed garment 652 is then moved manually by the operator to the second heat press 610b, which performs the transfer operation. The garment 652 is placed on the second lower platen 640b and aligned using the lasers 656 and garment marks 658 if provided. A section of DTF film 616 carrying a heat-transfer pattern 618 is either automatically fed from the roll 614 by the mechanism 669 or manually positioned over the garment. The operator then presses the second start button 667b. The second lower platen 640b moves inward to the transfer position under the second upper platen 650b. The second upper platen 650b lowers and applies a controlled combination of temperature, pressure, and time to transfer the pattern 618 to the garment. After the dwell time, the upper platen 650b lifts while the film 616 remains momentarily in contact with the garment to allow a controlled cooling interval. The film is then peeled away automatically or manually, depending on the selected mode (hot, warm, or cold peel).

While waiting for the transfer operation to complete, the operator may load a new shirt on the lower platen of the pre press station and press the start button 667a.

The transferred garment 652 is then moved manually to the third heat press 610c for post-pressing. The operator places the garment on the third lower platen 640c. An optional finishing sheet may be placed over the transferred pattern 618 to impart a desired surface effect, such as matte or glossy finish. The operator presses the third start button 667c, and the third lower platen 640c moves inward under the third upper platen 650c. The upper platen 650c descends to apply heat and pressure for the programmed dwell time. Afterward, the upper platen 650c rises, and the lower platen 640c moves outward, allowing the operator to remove the finished garment.

The three stations 610a, 610b, and 610c may operate simultaneously but independently, allowing a single operator to manage continuous production. For example, while one garment is being pre-pressed at the first station, another is being transferred at the second, and a third is being post-pressed at the third. Each station can begin its next cycle as soon as its platen returns to the out position, maximizing throughput. Anytime the garment can be moved from not pre pressed pile, to the pre press station, to the transfer station, to the post press station, to the completed pile, the garment is moved. For example, when the lower platens of the transfer station and the post press station are in the out position, this means that the user can move the completed post press garment to the completed pile and move the completed transferred garment to the post press station.

In relation to the post press station, rather than using individual finishing sheets, the third station 610c may include a roll-feeding mechanism similar to the second station's roll 614 and mechanism 669. In this case, a continuous roll of finishing material is fed between the third upper platen 650c and the garment 652, applying a consistent surface finish across production cycles.

Each station may include an HMI display to adjust or monitor its temperature, pressure, dwell time, and peel delay. Optionally, a centralized controller can coordinate all stations, providing data logging for production tracking and uniformity verification.

All of the features described for the previous embodiments—such as edge detection and guiding, print-edge calibration, variable peel timing, and safety sensors—can be incorporated into device 610 where applicable. Likewise, the laser alignment system and garment-holding features from FIGS. 1-13 can be applied to this embodiment.

The embodiment of FIG. 53 thus represents a high-efficiency, multi-station DTF heat-transfer system that performs pre-press, transfer, and post-press operations simultaneously using multiple independently controlled presses. Each station can integrate the alignment lasers, roll-feeding mechanisms, vacuum garment hold-down, and safety systems described in earlier embodiments, and the system may be configured as either a linear or rotary layout depending on space and production requirements.

Referring back to FIGS. 1-13, a variant of this embodiment is disclosed. This embodiment operates according to the same general principles and uses many of the same structural components, including the upper platen 50, lower platen 40, roll-feeding mechanism 69, and associated spindles 20a, 20b, motors 28a, 28b, rollers 30, guide 33, edge sensor 34, and print-edge detector 37. Unless otherwise stated, components identified with the same reference numbers perform the same function as in FIGS. 1-13.

The distinguishing feature of this embodiment is that the film 16 used in roll 14 is modified to include deliberate gaps between consecutive heat-transfer patterns 18. Each heat-transfer pattern 18 may be separated from the next by an unprinted section or “gap” of the film, referred to as a pre-press region and a post-press region, respectively. The pre-press region is advanced beneath the upper platen 50 before each transfer operation to perform a pre-press step directly on the garment 52 without any printed material between the platen and the garment. The post-press region is advanced beneath the upper platen 50 after the transfer step to provide a finishing operation that can apply a coating, such as a matte or glossy finish, to the transferred pattern.

The film 16 thus alternates between pre-press region, heat-transfer pattern 18, and post-press region. These regions are spaced so that when one garment 52 is loaded on the lower platen 40 and the roll 14 is unwound, the pre-press region is positioned beneath the upper platen 50 for the pre-press operation. After pre-pressing, the roll-feeding mechanism 69 advances the film 16 until the heat-transfer pattern 18 is located beneath the upper platen 50 for the transfer operation. After transfer, the roll-feeding mechanism 69 again advances the film 16 until the post-press region is positioned under the upper platen 50 for the final finishing or post-press operation.

The pre-press region of the film 16 is uncoated and allows heat and pressure to pass uniformly through to the garment surface. The post-press region may optionally be coated with a thin layer of a finish-enhancing material that imparts specific optical or tactile properties to the heat-transferred image. For example, a matte coating can be used to reduce shine, a gloss coating can increase luster, and other coatings can improve durability, surface smoothness, or scratch resistance of the finished image. The post-press region thereby serves as an integrated finishing sheet, eliminating the need for separate manual placement of such materials.

The machine 10 of this variant operates in largely the same sequence as described for FIGS. 1-13. The operator first powers the system, loads the film 16 onto the supply spindle 20a, threads it through rollers 30, and attaches it to take-up spindle 20b. The edge sensor 34 and guide 33 are adjusted using bracket 36 and thumb wheel 37 to ensure proper lateral tracking of the film 16, while the print-edge detector 37 is used to calibrate the longitudinal advance distance for centering each heat-transfer pattern 18 over the garment 52. The upper platen 50 is heated to the desired temperature, and the lower platen 40 is prepared for loading.

The lower platen 40 is extended to the out position for loading, as in the earlier embodiment. A shirt 52 or other garment is placed over the lower platen 40 so that only one fabric layer lies on the pressing surface. The garment may be aligned using laser modules 56 projecting laser beams 60, as described in the embodiment of FIGS. 1-13. These lasers help the operator align garment marks 58 (for example, a neckline or centerline datum) so that each shirt is positioned consistently. The garment may also be held in place by vacuum ports 55 or by a peripheral mechanical frame.

Once the garment is aligned and secured, the operator initiates the cycle using the foot pedal 54 or start button. The lower platen 40 traverses to the in position beneath the upper platen 50. The roll-feeding mechanism 69 positions the pre-press region of film 16 under the upper platen. The upper platen 50 then descends and applies heat and pressure for a short dwell time. The pre-press operation removes wrinkles and moisture from the garment surface, creating an optimal base for transfer.

After pre-pressing, the upper platen 50 lifts to its raised position. The roll-feeding mechanism 69 advances the film 16 forward until the next heat-transfer pattern 18 is located beneath the upper platen 50. Once the pattern is in position, the upper platen 50 lowers again to press the pattern 18, the film 16, and the garment 52 together at a controlled temperature, pressure, and dwell time. Heat and pressure activate the adhesive layer of the pattern 18, bonding it to the garment surface.

After the programmed dwell time, the upper platen 50 lifts partially, as shown in FIG. 12 of the earlier embodiment, creating a controlled cooling interval. The frame 44 and film 16 remain in the lowered position during this interval, allowing the garment 52 to cool while the film 16 stays in contact with the transferred pattern 18. The delay between lifting the upper platen 50 and raising the frame 44 may be between 1 and 60 seconds (more preferably between 7 to 10 seconds), depending on the type of film. This staged timing produces a hot-peel, warm-peel, or cold-peel cycle as desired. The sequence—upper platen lift followed by delayed film lift—remains one of the key advantages of the present invention.

After the peel delay has elapsed, the frame 44 and film 16 rise together, peeling the film from the garment surface. The roll-feeding mechanism 69 then advances the film so that the next post-press region is positioned beneath the upper platen 50. The upper platen 50 lowers again to apply a short finishing press over the transferred pattern. If the post-press region of the film includes a coating, this step transfers that coating onto the garment surface, producing the desired finish. If the post-press region is uncoated, the operation merely provides a mechanical and thermal smoothing of the printed area.

After the post-press dwell, the upper platen 50 rises, and the lower platen 40 moves outward to the loading position. The operator removes the finished garment 52 and may immediately load another. While the operator unloads and reloads, the roll-feeding mechanism 69 advances the film 16 so that the pre-press region of the next cycle is staged beneath the upper platen 50.

This variant of machine 10 therefore enables the full DTF heat-transfer cycle—pre-press, transfer, and post-press—using a single upper platen 50 and a modified film 16 having spaced heat-transfer patterns 18 separated by designated pre-press and post-press regions. The sequencing of film advance allows continuous operation with minimal manual intervention.

The system may include optional features previously described, including safety sensors that prevent platen motion when the operator's hands are detected in front of the press zone, vacuum or magnetic garment hold-down, and integrated laser alignment.

As with all previously discussed embodiments, the features described here—including the roll-feeding system, peel-timing control, laser alignment modules, garment-holding mechanisms, and temperature-sensing feedback—can be incorporated into any of the other embodiments described herein, where appropriate.

As used in this description, the same reference refers to the common number. For example, lower platen may be identified as 40 or 140. They refer to the same lower platen but for different embodiments. They may share the same characteristics of each other unless otherwise expressly stated or implied by the context.

It is contemplated that any of the machines described herein may include additional or alternative structural and functional features, either individually or in combination, to improve versatility, automation, and production efficiency. These features may be incorporated into any of the embodiments disclosed herein. Where the structure or function of a feature has already been described, it may be referenced and incorporated without further repetition.

In some embodiments, the lower platen 40 may be configured to move in directions other than the in-out direction. For example, in certain versions, the lower platen may move side to side relative to the machine frame. This side-to-side motion may be achieved by mounting the lower base on a set of linear guide rails oriented laterally across the front of the machine. Such a configuration allows the lower platen to be positioned under one of two upper platens in a dual-station arrangement or shifted laterally for ergonomic loading. The lower platen may also move between an in position and an out position, as previously described. The in-out motion may be powered by a pneumatic cylinder or an electric actuator controlled by the machine's controller. In alternative versions, the lower platen may be moved manually by the operator. The end of the in position of the lower platen may be defined by a stopper whose location can be adjusted to fine-tune the platen's depth of travel, ensuring precise alignment of the garment under the upper platen during pressing. This arrangement allows the same base structure to be adapted for a variety of press configurations, including drawer-style, shuttle-style, and side-to-side systems.

In another aspect, any of the embodiments disclosed herein may include a tilting transfer head or film-handling mechanism designed to facilitate controlled peeling of the film from the garment surface. In one form, the upper platen or the roll-to-roll film carriage may be configured to tilt slightly about a transverse axis during the peel phase so that one edge of the transfer lifts before the other. This motion initiates a uniform, controlled peel and reduces the likelihood of the pattern image tearing or partial release. The tilt may be actuated mechanically by a cam or electronically by differential actuation of the platen lift mechanism. This feature is particularly beneficial in automated peel sequences, such as in the continuous-feed systems, where peeling begins at one end of the transfer and progresses smoothly across the pattern.

An AI-powered camera system may also be integrated into any embodiment to monitor and correct transfer alignment automatically. The camera may be positioned above the press zone and equipped with image-recognition software trained to detect both the position of the printed pattern on the film and the position of the garment on the lower platen. Misalignments can occur if the roll-feeding mechanism fails to advance the film precisely or if the garment is placed slightly off-center. The AI camera detects such deviations and directs the controller to make corrective movements before pressing. In one implementation, the system may move the lower platen slightly in the X-Y plane using motorized actuators. In another, the film-handling system or the transfer head may make small positional adjustments to center the pattern over the garment. The AI alignment feature thus provides automated correction in both horizontal directions, ensuring consistent placement from garment to garment and reducing waste from misaligned transfers.

The garments may be secured to the lower platen using one or more systems to prevent movement as the platen travels between positions. This feature ensures that the garment remains stationary even when the lower platen slides in or out, or moves side to side, and during the application of pressure. In one implementation, a vacuum hold-down system may be employed. The upper surface of the lower platen includes a series of ports connected to a vacuum source that draws the garment flat against the surface. Alternatively, a mechanical frame may be used to clamp the garment around the periphery of the platen. The frame may be hinged or magnetically attachable to allow quick release after pressing. In yet another form, magnets may be used to hold the garment in place. A plurality of small magnetic clamps may placed along the edges of the platen to secure the garment fabric without obstructing the transfer area. Each of these garment-retention systems can be used individually or in combination depending on garment type and machine configuration.

Another feature applicable to any embodiment relates to the control of film peeling temperature and timing. The system may be programmed to perform hot, warm, or cold peels, depending on the transfer film used. In a hot peel cycle, the upper platen and film lift away from the garment simultaneously or nearly simultaneously, releasing the film while the adhesive is still warm. In a warm peel cycle, the upper platen lifts first and remains elevated for a short cooling interval—typically between 1 second to 60 seconds, and more preferably between 7-10 seconds—before the film is lifted, allowing the transfer to cool slightly for cleaner separation. In a cold peel cycle, the upper platen lifts first and a longer delay is introduced before the film is removed, allowing the pattern to cool further. Preferably, air is blown over the surface of the film (as discussed herein) to reduce the temperature as close to the ambient temperature as possible, and thus effectuate a cold peel. The selection between hot, warm, and cold peel modes may be made through the HMI or may be automatic based on film type. In addition to timing control, the system may include a tilting or angular peel feature, in which the roll-to-roll film mechanism or upper platen assembly tilts slightly before lifting. This causes one edge of the film to peel away first, followed by the remainder, creating a smoother separation and reducing stress on the transferred image.

To further improve peel quality, an active cooling or forced-air assist system may be integrated into the machine. Instead of waiting passively for the transfer to cool, one or more air nozzles or fans may direct ambient or cooled air across the surface of the film immediately after the upper platen is lifted but before peeling begins. The airflow accelerates cooling and stabilizes the adhesive layer, making cold-peel operation practical even in high-volume production environments. The airflow may be controlled automatically by the same timing logic that governs the peel delay, and its temperature or intensity may be adjustable through the HMI.

In yet another feature, any of the embodiments described herein may incorporate integrated temperature and pressure sensing systems to provide real-time feedback on process conditions. Sensors adjacent to the upper platen can measure not only the platen setpoint temperature but also the actual temperature at the surface of the garment during pressing. For example, an infrared temperature sensor may be directed toward the garment to measure its true surface temperature. Similarly, pressure sensors distributed across the platen or within the actuation system can measure the applied pressure during the dwell period. The controller may use these readings to maintain uniform heat and pressure across the garment surface and to verify that each cycle meets the programmed specifications. Data from these sensors may also be stored as part of a traceability log, ensuring quality control for industrial customers.

An optional color registration and alignment system may also be provided. This system employs a vision module—typically a high-resolution camera 702 mounted above the lower platen—to ensure that the design (heat transfer pattern) is centered and straight relative to the garment seams. During setup, the camera 702 (see FIG. 9) captures an image of the garment after it is placed on the lower platen (see FIG. 9). The associated software analyzes the image to identify the position and orientation of the garment seams 704 or edges 704. The software then displays visual indicators on the HMI or monitor, instructing the operator to move the garment slightly upward/downward 716, side-to-side 718, or rotationally 720 until the garment is properly aligned. The system notifies the operator when the garment is properly aligned with a visual or audible notification. Once the software confirms correct alignment, the garment may be locked in place using the vacuum (e.g., automatically turned on), mechanical frame, or magnetic retention systems described above. This ensures that each transfer is applied precisely and consistently across successive garments, even if the garments vary slightly in shape or construction.

Each of the above features can be incorporated into any of the embodiments described herein, either individually or in combination, wherever appropriate. For example, the lateral-moving lower platen described above may be used in conjunction with the AI camera system and the garment-holding mechanisms to create an adaptive alignment platform that automatically positions and holds garments for transfer. Similarly, the forced-air cooling system and tilting peel mechanism can be applied to any of the single-or multi-station embodiments to improve cycle time and transfer quality. These enhancements may be selectively implemented according to the desired level of automation, throughput, and precision, and can be added without altering the fundamental structure or operation of the machines disclosed herein.

The garment as used herein refers to any textile article onto which a heat-transfer pattern is to be applied. The garment may include, but is not limited to, shirts, sweatshirts, hoodies, pants, fabric panels, tote bags, or any other fabric-based substrate suitable for receiving a heat-transfer image. In one typical use, the garment is a shirt constructed from cotton, polyester, or a cotton-polyester blend.

It is contemplated that the various structural and functional features described in connection with any one embodiment of the invention may be incorporated into any of the other embodiments, either individually or in combination, unless stated otherwise. For example, elements such as the laser alignment system, vacuum hold-down arrangement, film edge sensing and guiding system, drawer-style lower platen, throat configuration, or multi-platen sequencing arrangement may be interchanged or combined as appropriate to meet specific production or design requirements. The selection and combination of these features are not limited to the particular embodiments shown and described herein, and one of ordinary skill in the art will recognize that such modifications can be made without departing from the scope and spirit of the invention.

While the foregoing embodiments describe machines in which the lower platen translates horizontally between an in position beneath the upper platen and an out position accessible to the operator, it is expressly contemplated that the direction of horizontal motion may be reversed or that the upper platen itself may be configured to move horizontally relative to a stationary lower platen. Similarly, although the embodiments herein generally depict the upper platen as the vertically movable component that applies heat and pressure to the garment and film, the inverse arrangement is also contemplated, wherein the lower platen is vertically actuated to move upward against a fixed upper platen to perform the pressing operation. Any combination of horizontal and vertical motion between the upper and lower platens that achieves equivalent relative positioning and pressure application is considered within the scope of the present disclosure.

The foregoing variations in platen movement may be incorporated into any of the embodiments described herein, including but not limited to the single-station, dual-station, and multi-station configurations shown in FIGS. 1 through 53. In each case, the relative motion between the upper and lower platens—whether achieved by translating the upper platen, the lower platen, or both—serves the same functional purpose of positioning the garment and film within the press zone and applying controlled heat and pressure to accomplish pre-press, transfer, and post-press operations. Accordingly, the specific mechanical implementation of platen motion, whether by moving one or both platens in horizontal or vertical directions, should be understood as an interchangeable design choice that does not depart from the spirit and scope of the present invention.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. An automatic heat-transfer press machine comprising:
a lower platen configured to support a garment thereon;
an upper platen defining a heated surface configured to press a sheet carrying a printed pattern against the garment, the upper platen configured to traverse vertically in a linear pathway between an up position and a down position;
a roll-feeding mechanism configured to feed a sheet along a sheet path from a supply roll, through a press zone to a take-up roll; and
a controller configured to operate the upper platen and the roll-feeding mechanism independently such that, during a press cycle,
(a) the upper platen lifts away from the sheet after a dwell period while the sheet remains at an elevation of the garment to permit controlled cooling of the printed pattern on the garment, and
(b) the roll-feeding mechanism thereafter lifts or peels the sheet away from the garment following a time delay.

2. The heat-transfer press machine of claim 1 wherein the delay is selectively programmable between approximately one second and one minute to achieve hot-peel and warm-peel operation modes.

3. The heat-transfer press machine of claim 2, wherein the controller includes a user interface configured to allow an operator to program a time period of the delay between lifting of the upper platen and lifting of the roll-feeding mechanism away from the garment.

4. The heat-transfer press machine of claim 1, wherein the controller automatically selects the delay based on a detected type of sheet or a stored recipe corresponding to a particular transfer material.

5. The heat-transfer press machine of claim 1, further comprising an airflow system configured to direct ambient or cooled air across the garment during the delay to accelerate cooling of the printed pattern.

6. The heat-transfer press machine of claim 5, wherein the airflow system includes one or more fan blowers or air nozzles directed between the upper platen and the garment, and wherein the controller regulates a temperature of the air during the delay.

7. The heat-transfer press machine of claim 1, wherein the roll-feeding mechanism is configured to tilt about a transverse axis before lifting the sheet, thereby initiating a peel from one side of the printed pattern prior to peeling the remainder of the sheet so that the sheet is peeled off of the printed pattern from the one side to an opposite side.

8. The heat-transfer press machine of claim 1, further comprising a non-contact temperature sensor configured to measure a temperature of a surface of the garment, wherein the controller regulates a temperature of the upper platen based on a measured garment temperature reaching a target value.

9. The heat transfer press machine of claim 1 wherein the sheet is a direct to film (DTF) film or heat transfer paper.

10. An automatic press machine comprising:
a lower platen configured to receive a garment;
a roll-feeding mechanism configured to advance a sheet carrying a series of printed patterns between upper and lower platens;
a print-edge detector positioned along the sheet path and configured to detect a leading edge of the printed pattern on the sheet; and
a controller programmed to advance the sheet after detection of the leading edge for a calibrated distance or time duration such that the printed pattern is properly positioned relative to a garment on the lower platen.

11. The heat-transfer press machine of claim 10 wherein the controller stores adjustable calibration parameters corresponding to different printed pattern spacing and printed pattern sizes, enabling repeatable alignment of the printed patterns.

12. The heat-transfer press machine of claim 10, wherein a print-edge detector comprises an infrared, optical or infrared sensor configured to detect contrast between the printed pattern and an unprinted region of the sheet for identifying a leading edge of the printed pattern.

13. The heat-transfer press machine of claim 10, wherein a calibrated advancement distance is adjustable through a user interface and is storable as part of a job-specific memory preset.

14. The heat-transfer press machine of claim 10, wherein a print-edge detector regulates vertical placement of the printed pattern on the garment and cooperates with a front to back edge sensor to regulate a left to right placement of the printed pattern on the garment.

15. The heat-transfer press machine of claim 10, further comprising an artificial intelligence (AI) camera positioned above the lower platen and configured to verify printed pattern placement in relation to the garment after sheet advancement and before transfer.

16. The heat-transfer press machine of claim 15, wherein the controller adjusts either a sheet position or the lower platen position in response to alignment feedback from the AI camera to correct misalignment before pressing.

17. The heat-transfer press machine of claim 10, wherein a print-edge detector detects each printed pattern automatically during continuous operation so that successive garments receive identical pattern positioning without manual adjustment.

18. An automatic heat-transfer press machine comprising:
a roll-feeding mechanism configured to advance a sheet carrying printed patterns toward a press zone;
a guide disposed along a sheet path and rotatable about an axis to shift the sheet's location relative to a front to back direction of the machine for adjusting a vertical placement of the printed pattern relative to a lower platen;
an edge sensor configured to monitor a side edge of the sheet and generate a positional feedback signal; and
a controller configured to command movement of the guide in response to the feedback signal to adjust a vertical position of each printed pattern relative to a garment supported on the lower platen,
wherein the guide maintains consistent pattern landing height on the garment despite lateral drift during repeated cycles.

19. The heat transfer press machine of claim 18 wherein the movement is a rotational movement in a clockwise or counterclockwise direction or lateral in and out directional movement.

20. The heat-transfer press machine of claim 18, wherein the guide comprises a pair of rollers mounted on a pivot frame rotated by an actuator under command of the controller.

21.-78. (canceled)
